(19) United States
(12) Patent Application Publication
(10) Pub. No.: US 2025/0119915 A1
(43) Pub. Date: Apr. 10, 2025

(54) ORTHOGONAL COVER CODES FOR UPLINK CONTROL INFORMATION MULTIPLEXING WITH PHYSICAL UPLINK SHARED CHANNELS

(71) Applicant: QUALCOMM Incorporated, San Diego, CA (US)

(72) Inventors: Liangping MA, San Diego, CA (US); Xiao Feng WANG, San Diego, CA (US); Alberto RICO ALVARINO, San Diego, CA (US); Ayan SENGUPTA, San Diego, CA (US); Syed Hashim Ali SHAH, San Diego, CA (US); Peter GAAL, San Diego, CA (US); Gokul SRIDHARAN, Sunnyvale, CA (US)

(21) Appl. No.: 18/472,701

(22) Filed: Sep. 22, 2023

(51) Int. Cl. H04W 72/21; H04L 5/00; H04L 27/26

(52) U.S. Cl. CPC H04W 72/21; H04L 5/0051; H04L 27/26035

(57) ABSTRACT

Various aspects of the present disclosure generally relate to wireless communication. In some aspects, a user equipment (UE) may map uplink control information (UCI) bits and uplink shared channel (UL-SCH) data bits to a first subset of resources associated with a physical uplink shared channel (PUSCH). The UE may copy symbols associated with the UCI bits and the UL-SCH data bits from the first subset of resources to one or more remaining subsets of resources. The UE may apply an orthogonal cover code (OCC) across a plurality of subsets of resources, including the first subset of resources and the one or more remaining subsets of resources, associated with the PUSCH. The UE may transmit, based at least in part on the OCC applied across the plurality of subsets of resources, multiplexed UCI bits and UL-SCH data bits. Numerous other aspects are described.

### INTRODUCTION

Aspects of the present disclosure generally relate to wireless communication and to techniques and apparatuses for uplink control information (UCI) multiplexing on an uplink shared channel.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to an apparatus for wireless communication at a user equipment (UE). The apparatus may include one or more memories and one or more processors coupled to the one or more memories. The one or more processors may be configured to cause the UE to map uplink control information (UCI) bits and uplink shared channel (UL-SCH) data bits to a first subset of resources associated with a physical uplink shared channel (PUSCH). The one or more processors may be configured to cause the UE to copy symbols associated with the UCI bits and the UL-SCH data bits from the first subset of resources to one or more remaining subsets of resources associated with the PUSCH, to obtain copied symbols associated with the UCI bits and the UL-SCH data bits, based at least in part on a repetition pattern. The one or more processors may be configured to cause the UE to apply an orthogonal cover code (OCC) across a plurality of subsets of resources, including the first subset of resources and the one or more remaining subsets of resources, associated with the PUSCH based at least in part on the repetition pattern. The one or more processors may be configured to cause the UE to transmit, based at least in part on the OCC applied across the plurality of subsets of resources, multiplexed UCI bits and UL-SCH data bits, the multiplexed UCI bits and UL-SCH data bits being based at least in part on the symbols associated with the UCI bits and the UL-SCH bits associated with the first subset of resources and the copied symbols associated with the UCI bits and the UL-SCH data bits associated with the one or more remaining subsets of resources.

Some aspects described herein relate to a method of wireless communication performed at a UE. The method may include mapping UCI bits and UL-SCH data bits to a first subset of resources associated with a PUSCH. The method may include copying symbols associated with the UCI bits and the UL-SCH data bits from the first subset of resources to one or more remaining subsets of resources associated with the PUSCH, to obtain copied symbols associated with the UCI bits and the UL-SCH data bits, based at least in part on a repetition pattern. The method may include applying an OCC across a plurality of subsets of resources, including the first subset of resources and the one or more remaining subsets of resources, associated with the PUSCH based at least in part on the repetition pattern. The method may include transmitting, based at least in part on the OCC applied across the plurality of subsets of resources, multiplexed UCI bits and UL-SCH data bits, the multiplexed UCI bits and UL-SCH data bits being based at least in part on the symbols associated with the UCI bits and the UL-SCH bits associated with the first subset of resources and the copied symbols associated with the UCI bits and the UL-SCH data bits associated with the one or more remaining subsets of resources.

Some aspects described herein relate to a non-transitory computer-readable medium that stores a set of instructions for wireless communication by a UE. The set of instructions, when executed by one or more processors of the UE, may cause the UE to map UCI bits and UL-SCH data bits to a first subset of resources associated with a PUSCH. The set of instructions, when executed by one or more processors of the UE, may cause the UE to copy symbols associated with the UCI bits and the UL-SCH data bits from the first subset of resources to one or more remaining subsets of resources associated with the PUSCH, to obtain copied symbols associated with the UCI bits and the UL-SCH data bits, based at least in part on a repetition pattern. The set of instructions, when executed by one or more processors of the UE, may cause the UE to apply an OCC across a plurality of subsets of resources, including the first subset of resources and the one or more remaining subsets of resources, associated with the PUSCH based at least in part on the repetition pattern. The set of instructions, when executed by one or more processors of the UE, may cause the UE to transmit, based at least in part on the OCC applied across the plurality of subsets of resources, multiplexed UCI bits and UL-SCH data bits, the multiplexed UCI bits and UL-SCH data bits being based at least in part on the symbols associated with the UCI bits and the UL-SCH bits associated with the first subset of resources and the copied symbols associated with the UCI bits and the UL-SCH data bits associated with the one or more remaining subsets of resources.

Some aspects described herein relate to an apparatus for wireless communication. The apparatus may include means for mapping UCI bits and UL-SCH data bits to a first subset of resources associated with a PUSCH. The apparatus may include means for copying symbols associated with the UCI bits and the UL-SCH data bits from the first subset of resources to one or more remaining subsets of resources associated with the PUSCH, to obtain copied symbols associated with the UCI bits and the UL-SCH data bits, based at least in part on a repetition pattern. The apparatus may include means for applying an OCC across a plurality of subsets of resources, including the first subset of resources and the one or more remaining subsets of resources, associated with the PUSCH based at least in part on the repetition pattern. The apparatus may include means for transmitting, based at least in part on the OCC applied across the plurality of subsets of resources, multiplexed UCI bits and UL-SCH data bits, the multiplexed UCI bits and UL-SCH data bits being based at least in part on the symbols associated with the UCI bits and the UL-SCH bits associated with the first subset of resources and the copied symbols associated with the UCI bits and the UL-SCH data bits associated with the one or more remaining subsets of resources.

Aspects generally include a method, apparatus, system, computer program product, non-transitory computer-readable medium, user equipment, base station, network entity, network node, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a frequency-domain (FD) orthogonal cover code (OCC) multiplexing of two UEs, in accordance with the present disclosure.

FIGS. 5A-5D are diagrams illustrating examples of an uplink control information (UCI) multiplexing with a physical uplink shared channel (PUSCH), in accordance with the present disclosure.

FIG. 6 is a diagram illustrating an example associated with OCC for UCI multiplexing with PUSCH, in accordance with the present disclosure.

FIGS. 7A-7F are diagrams illustrating examples associated with OCC for UCI multiplexing with PUSCH, in accordance with the present disclosure.

FIGS. 8A-8B are diagrams illustrating examples associated with OCC for UCI multiplexing with PUSCH, in accordance with the present disclosure.

FIGS. 9A-9G are diagrams illustrating examples associated with OCC for UCI multiplexing with PUSCH, in accordance with the present disclosure.

FIGS. 10A-10B are diagrams illustrating examples associated with OCC for UCI multiplexing with PUSCH, in accordance with the present disclosure.

FIGS. 11A-11C are diagrams illustrating examples associated with OCC for UCI multiplexing with PUSCH, in accordance with the present disclosure.

FIGS. 12A-12B are diagrams illustrating examples associated with OCC for UCI multiplexing with PUSCH, in accordance with the present disclosure.

FIG. 13 is a diagram illustrating an example associated with OCC for UCI multiplexing with PUSCH, in accordance with the present disclosure.

FIG. 14 is a diagram illustrating an example process associated with OCC for UCI multiplexing with PUSCH, in accordance with the present disclosure.

FIG. 15 is a diagram of an example apparatus for wireless communication, in accordance with the present disclosure.

FIG. 16 is a diagram illustrating an example of a hardware implementation for an apparatus employing a processing system, in accordance with the present disclosure.

FIG. 17 is a diagram illustrating an example implementation of code and circuitry for an apparatus, in accordance with the present disclosure.

### DETAILED DESCRIPTION

A user equipment (UE) may transmit, to a network node, uplink control information (UCI) bits multiplexed on a physical uplink shared channel (PUSCH) for more efficient use of resources. The UCI bits may include coded bits for hybrid automatic repeat request (HARQ) acknowledgement (ACK) (HARQ-ACK), coded bits (e.g., an output of a channel encoder) for channel state information (CSI) and/or coded bits for configured grant (CG) UCI (CG-UCI) without HARQ-ACK. A “coded bit” may be a bit that has been encoded using a specific algorithm or coding scheme.

When the UE transmits the UCI bits multiplexed on the PUSCH, the UE may not create repetition of the UCI bits and/or the PUSCH in a frequency domain (FD) or in a time domain (TD). When the UCI bits are multiplexed with the PUSCH, a reserved HARQ-ACK, a CSI and/or an uplink shared channel (UL-SCH) may be transmitted via a physical resource block (PRB), but the reserved HARQ-ACK, a CSI and/or an UL-SCH may not be transmitted with repetition. Transmitting repetitions of the reversed HARQ-ACK, the CSI, and/or the UL-SCH may consume system resources, so the repetitions may be avoided to save the system resources.

Without repetition for the PUSCH with UCI multiplexing, no orthogonal cover code (OCC) may be applied to the PUSCH. An OCC may be a code applied to an uplink transmission by a UE to improve a multiplexing capacity. An OCC may be applied to allow the uplink transmission to be multiplexed with other uplink transmissions of other UEs. The OCC may include a code sequence, such as [+1 +1], [+1 −1] for length 2, [+1 +1 +1 +1], [+1 −1 +1 −1], [−1 +1 +1 −1] or [+1 +1 −1 −1] for length 4, which may be applied to symbols transmitted via the PUSCH. A “code sequence” may be a string of positively signed or negatively signed numbers. When the OCC is applied, a part of the code sequence may be applied to an original PUSCH and another part of the code sequence may be applied to a repeated PUSCH. Accordingly, without the repetition of the PUSCH, the OCC cannot be applied to the PUSCH. In this example, +1 from a code sequence may be applied to original bits, and +1 or −1 from the code sequence may be applied to repeated bits. However, with no repetition, the OCC cannot be applied to the PUSCH. Furthermore, when the OCC cannot be applied to the PUSCH, multiple UEs cannot be multiplexed using OCC. An inability to apply OCC to the PUSCH, due to no repetition being created when the UCI is multiplexed with the PUSCH, may degrade an overall system performance because multiplexing multiple UEs using OCC would increase a system capacity.

In various aspects of techniques and apparatuses described herein, a UE may create repetition during a UCI multiplexing with a PUSCH. The UE may repeat a demodulation reference signal (DMRS), a reserved HARQ-ACK, a CSI and/or a UL-SCH in one or more physical resource blocks (PRBs) associated with the UCI multiplexing with the PUSCH. One PRB may be associated with 12 subcarriers in an FD and 14 symbols in a TD. In order to enable the repetition, the PUSCH may be partitioned into a number of subsets, depending on a number of users (or UEs). A partitioning may be defined in a specification, or the partitioning may be based at least in part on signaling between the UE and a network node. The UE may create a mapping of UCI bits and UL-SCH bits in a subset of the PUSCH, and then the UE may copy the mapping of UCI bits and UL-SCH bits to one or more remaining subsets of the PUSCH, thereby resulting in the repetition of the DMRS, the reserved HARQ-ACK, the CSI and/or the UL-SCH. The UE may copy the mapping of UCI bits and UL-SCH bits in an FD and/or a TD. An OCC may be applied to each subset of the PUSCH. Resources associated with the PUSCH may be divided into two or more subsets, where a first subset may be associated with a first set of resources of the PUSCH, a second subset may be associated with a second set of resources of the PUSCH, and so on. For example, the UE may apply an OCC of +1 and +1 to two subsets associated with the PUSCH, respectively. Another UE may apply an OCC of +1 and −1 to two subsets associated with the PUSCH, respectively. As another example, a first UE may apply an OCC of [+1 +1 +1 +1] to four subsets associated with the PUSCH, respectively. A second UE may apply an OCC of [+1 +1 −1 −1] to four subsets associated with the PUSCH, respectively, and a third UE and a fourth UE may also apply appropriate OCCs to four subsets associated with the PUSCH. A length of the OCC (e.g., two or four) may correspond to a number of UEs. Thus, a repetition pattern may be created in the FD or in the TD, which may allow for OCC to be applied to a whole PUSCH, where different OCCs may be applied by different UEs. A network node may separate signals from different UEs based on the OCC being applied to the whole PUSCH. In other words, same OCC patterns may be generated using repetition, which may allow the network node to separate signals from different UEs. The network node may be aware of which OCC sequence is applied by different UEs. For example, the network node may be aware that an OCC sequence of [+1 +1] is applied by a first UE and an OCC sequence of [+1 −1] is applied by a second UE. The network node, based at least in part on knowledge of different OCC sequences applied by the different UEs, may be able to separate the signals from the different UEs.

In some aspects, by creating repetition during the UCI multiplexing with the PUSCH in accordance with a repetition pattern, OCC may be applied to the PUSCH. The OCC may allow communications associated with multiple UEs to be multiplexed. For example, an FD OCC may double a number of supported UEs using a same amount of resources due to unique orthogonal properties of the FD OCC. When multiplexing multiple users (or UEs) using OCC, an overall system capacity may be increased because more UEs may be supported with the same amount of resources, as compared to no multiplexing of multiple users using OCC. The repetition may allow the OCC to be applied, which may allow the multiple users to be multiplexed using the same amount of resources, thereby improving the system capacity. Increasing the system capacity may related to the number of UEs that are able to be supported with the same per UE data rate. Increasing the system capacity may also result in reduced network congestion and reduced access delay. Due to the repetition, a portion of an OCC sequence may be applied to one subset of the PUSCH, and another portion of the OCC sequence may be applied to another subset of the PUSCH. When a bandwidth is limited, the repetition may enable an ability to multiplex the multiple UEs using the same amount of resources, which may improve an overall system performance, such as reduced latency and higher throughput per UE.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

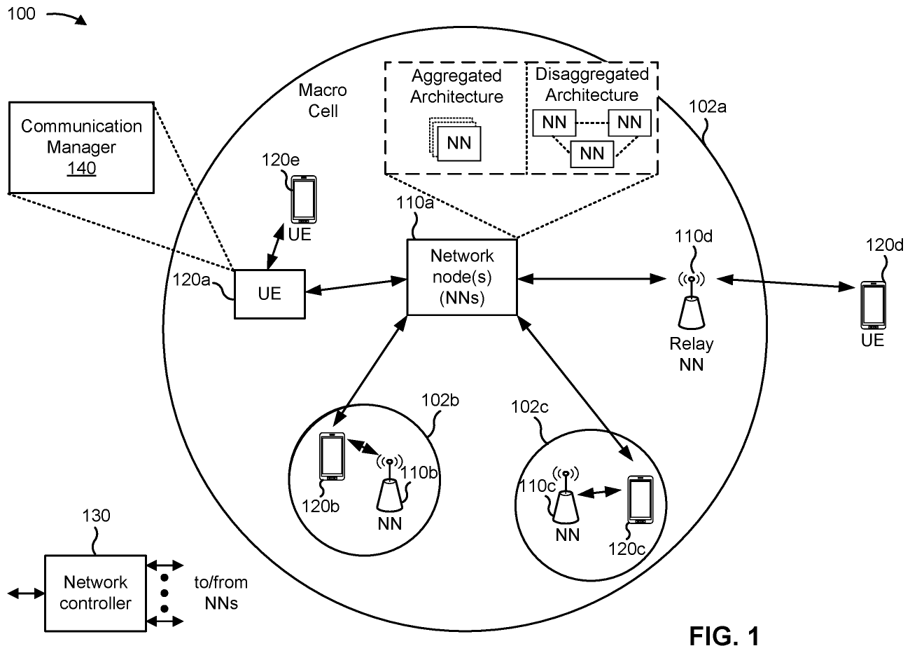

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

The electromagnetic spectrum is often subdivided, by frequency/wavelength, into various classes, bands, channels, etc. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., the UE 120) may include a communication manager 140. As described in more detail elsewhere herein, the communication manager 140 may map UCI bits and UL-SCH data bits to a first subset of resources associated with a PUSCH; copy symbols associated with the UCI bits and the UL-SCH data bits from the first subset of resources to one or more remaining subsets of resources associated with the PUSCH, to obtain copied symbols associated with the UCI bits and the UL-SCH data bits, based at least in part on a repetition pattern; apply an OCC across a plurality of subsets of resources, including the first subset of resources and the one or more remaining subsets of resources, associated with the PUSCH based at least in part on the repetition pattern; and transmit, based at least in part on the OCC applied across the plurality of subsets of resources, multiplexed UCI bits and UL-SCH data bits, the multiplexed UCI bits and UL-SCH data bits being based at least in part on the symbols associated with the UCI bits and the UL-SCH bits associated with the first subset of resources and the copied symbols associated with the UCI bits and the UL-SCH data bits associated with the one or more remaining subsets of resources. Additionally, or alternatively, the communication manager 140 may perform one or more other operations described herein.

As indicated above, FIG. 1 is provided as an example. Other examples may differ from what is described with regard to FIG. 1.

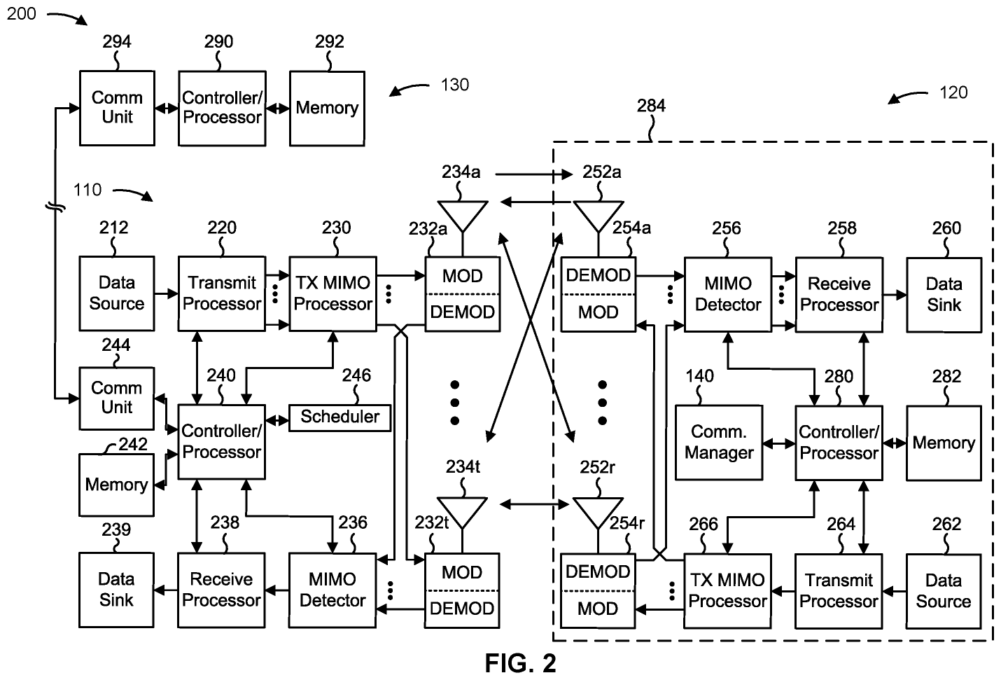

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a DMRS) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein.

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein.

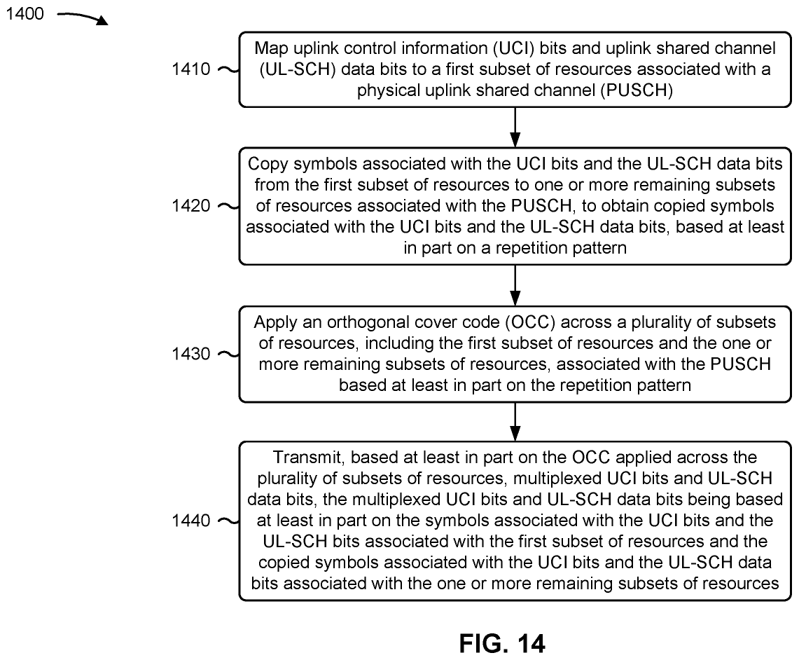

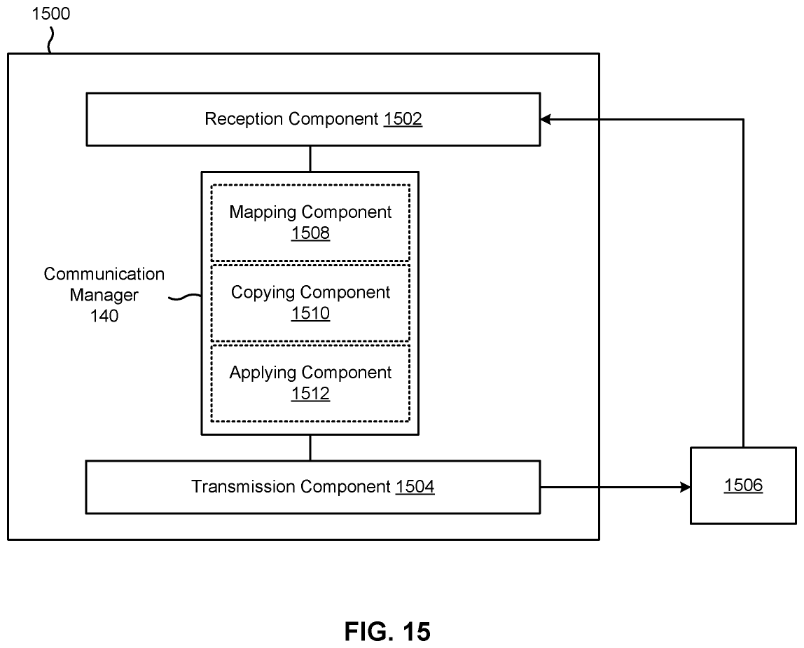

The controller/processor 240 of the network node 110, the controller/processor 280 of the UE 120, and/or any other component(s) of FIG. 2 may perform one or more techniques associated with OCC for UCI multiplexing with PUSCH, as described in more detail elsewhere herein. For example, the controller/processor 240 of the network node 110, the controller/processor 280 of the UE 120, and/or any other component(s) of FIG. 2 may perform or direct operations of, for example, process 1400 of FIG. 14, process 1500 of FIG. 15, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1400 of FIG. 14, process 1500 of FIG. 15, and/or other processes as described herein. In some examples, executing instructions may include running the instructions, converting the instructions, compiling the instructions, and/or interpreting the instructions, among other examples.

In some aspects, a UE (e.g., the UE 120) includes means for mapping UCI bits and UL-SCH data bits to a first subset of resources associated with a PUSCH; means for copying symbols associated with the UCI bits and the UL-SCH data bits from the first subset of resources to one or more remaining subsets of resources associated with the PUSCH, to obtain copied symbols associated with the UCI bits and the UL-SCH data bits, based at least in part on a repetition pattern; means for applying an OCC across a plurality of subsets of resources, including the first subset of resources and the one or more remaining subsets of resources, associated with the PUSCH based at least in part on the repetition pattern; and/or means for transmitting, based at least in part on the OCC applied across the plurality of subsets of resources, multiplexed UCI bits and UL-SCH data bits, the multiplexed UCI bits and UL-SCH data bits being based at least in part on the symbols associated with the UCI bits and the UL-SCH bits associated with the first subset of resources and the copied symbols associated with the UCI bits and the UL-SCH data bits associated with the one or more remaining subsets of resources. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

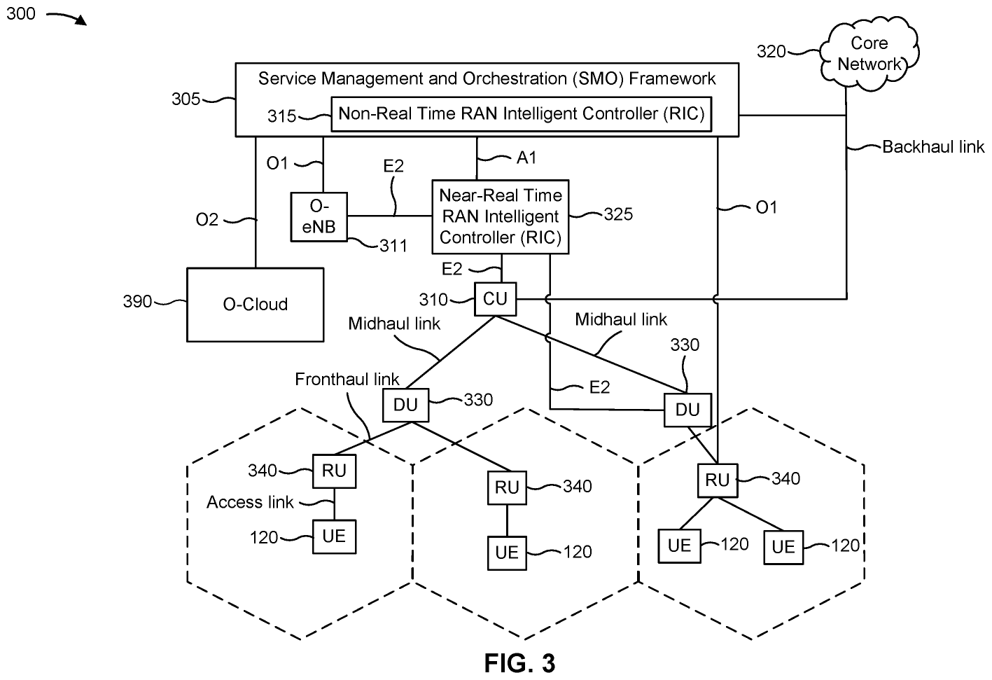

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

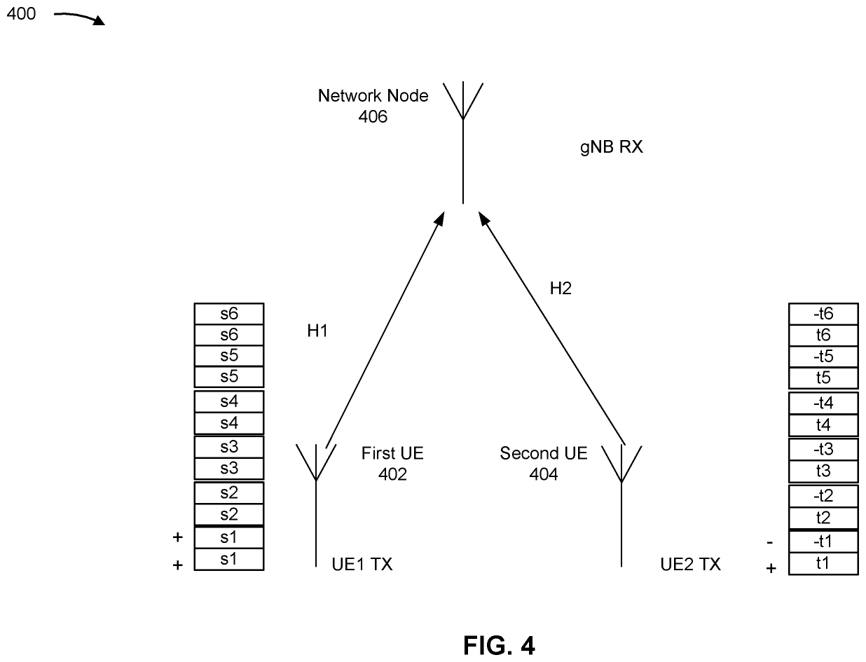

FIG. 4 is a diagram illustrating an example 400 of an FD OCC multiplexing of two UEs, in accordance with the present disclosure.

As shown in FIG. 4, for the FD OCC multiplexing of two UE, a first UE 402 (e.g., UE1 Tx) may transmit to a network node 406 (e.g., gNB Rx) over a first channel (H1), a second UE 404 (e.g., UE2 Tx) may transmit to the network node 406 over a second channel (H2), and the network node 406 may receive from both the first UE 402 and the second UE 404. The first UE 402 may transmit symbols to the network node 406 with a spreading factor of two. For example, the first UE 402 may transmit a first symbol (s1) two times, a second symbol (s2) two times, and so on, where both the first symbol and the second symbol may be positively signed symbols (e.g., +s1, +s1, +s2, +s2, and so on) due to positive OCCs being applied. The second UE 404 may also transmit signed symbols to the network node with a spreading factor of two. For example, the second UE 404 may transmit a first symbol (t1) two times, a second symbol (t2) two times, and so on, where the first symbol and the second symbol may be associated with both a positively signed symbol and a negatively signed symbol (e.g., +t1, −t1, +t2, −t2, and so on) due to both positive and negative OCCs being applied.

The network node 406, at a first resource element (or first tone), may receive +s1H1 and +t1H2. The network node 406, at a second resource element (or second tone), may receive +s1H1 and −t1H2, and so on. The network node 406 may add symbols for the first resource element and the second resource element. The network node 406 may perform (s1H1+t1H2)+(s1H1−t1H2), which results in 2s1H1. The network node may obtain 2s1H1 (e.g., 2 times s1) from the first UE 402. With an estimate of H1, e.g., via a DMRS signal, the network node 406 may estimate s1. The network node 406 may also subtract symbols for the first resource element and the second resource element. The network node 406 may perform s1H1+t1H2−(s1H1-t1H2), which results in 2t1H2. The network node 406 may obtain 2t1H2 (e.g., 2 times t1) from the second UE 404. With an estimate of H2, e.g., via a DMRS signal, the network node 406 may estimate t1.

As indicated above, FIG. 4 is provided as an example. Other examples may differ from what is described with regard to FIG. 4.

UCI bits may be multiplexed on a PUSCH. UCI bits may include coded bits for HARQ-ACK, coded bits for CSI part 1, coded bits for CSI part 2, and/or coded bits for CG-UCI without HARQ-ACK. An OCC may be applied to the PUSCH. An OCC may include a frequency-domain (FD) OCC including cyclic prefix (CP) orthogonal frequency division multiplexing (OFDM) (CP-OFDM) and discrete Fourier transform spread OFDM (DFT-s-OFDM). An OCC may include a time-domain (TD) OCC at a symbol level or slot level. When an OCC is applied to the PUSCH, the UCI bits may follow a same OCC pattern, which may allow a network node to be able to separate multiplexed PUSCHs from different UEs.

A UE may perform a UCI multiplexing with a PUSCH. When a number of HARQ-ACK bits is less than or equal to two, the UE may find reserved HARQ-ACK locations and mark the reserved HARQ-ACK locations on a grid. When the number of HARQ-ACK bits is greater than two, the UE may find resource elements (REs) for coded HARQ-ACK bits. The UE may find REs for CG-UCI bits when CG-UCI is present for transmission on the PUSCH without HARQ-ACK. The UE may find REs for coded CSI part 1 bits and coded CSI part 2 bits. The UE may find REs for coded uplink shared channel (UL-SCH) data bits. When a number of HARQ-ACK bits is less than or equal to two, the UE may find REs for the coded HARQ-ACK bits (e.g., using puncturing). The UE may map UCI bits and the UL-SCH data bits by reading bits in an FD, followed by a TD, at each RE other than DM-RS REs.

For a PUSCH with transport block (TB) over multiple slots (TBoMS), when a UCI is scheduled on slot x and slot x is among slots allocated to a PUSCH, a UCI multiplexing may occur on slot x.

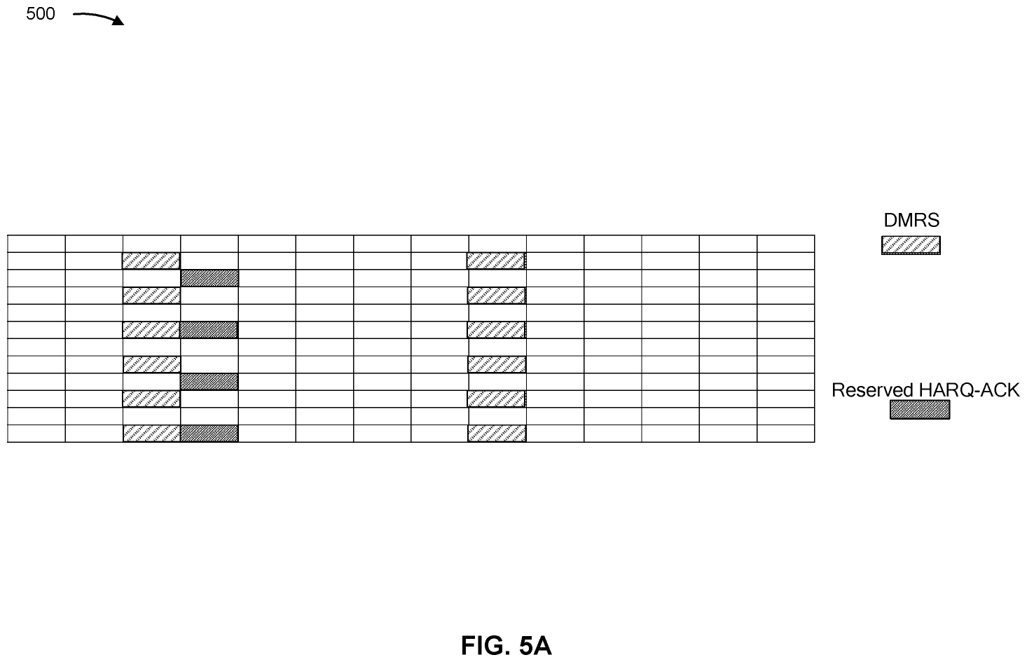

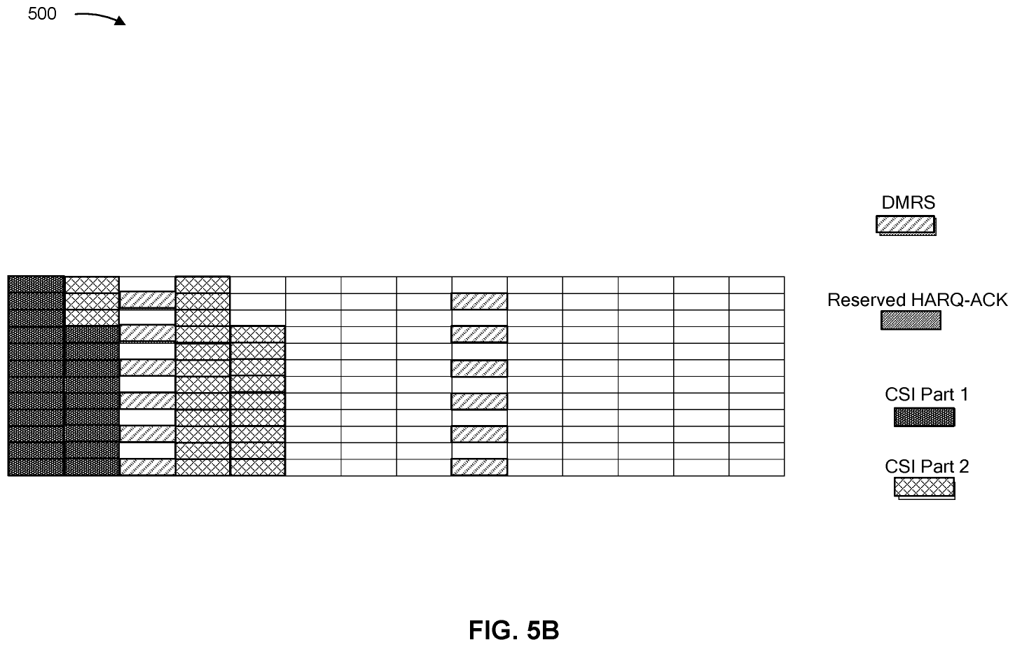

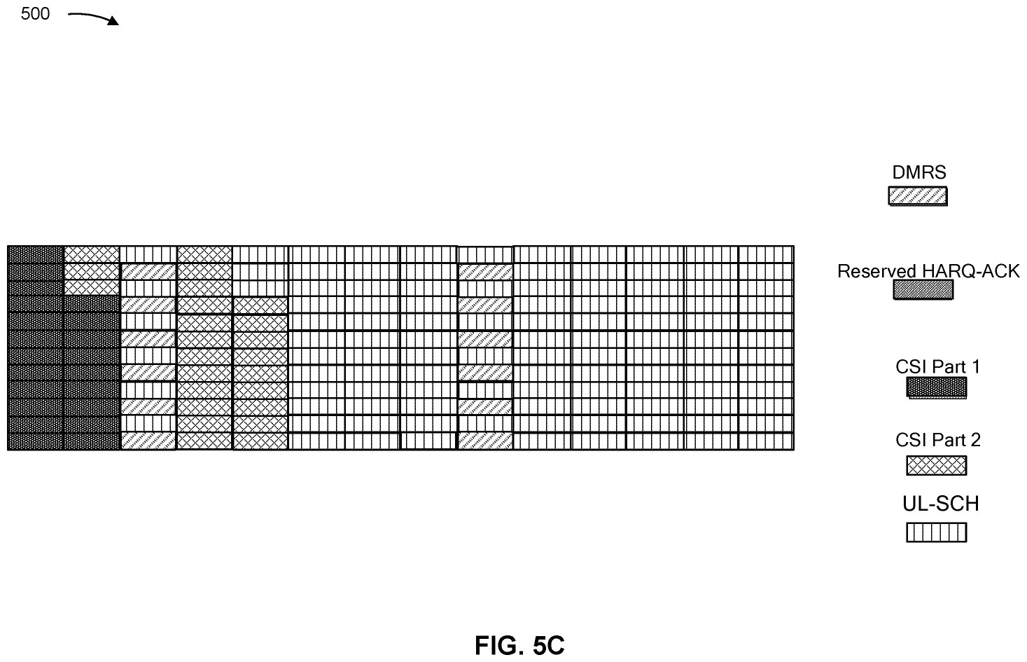

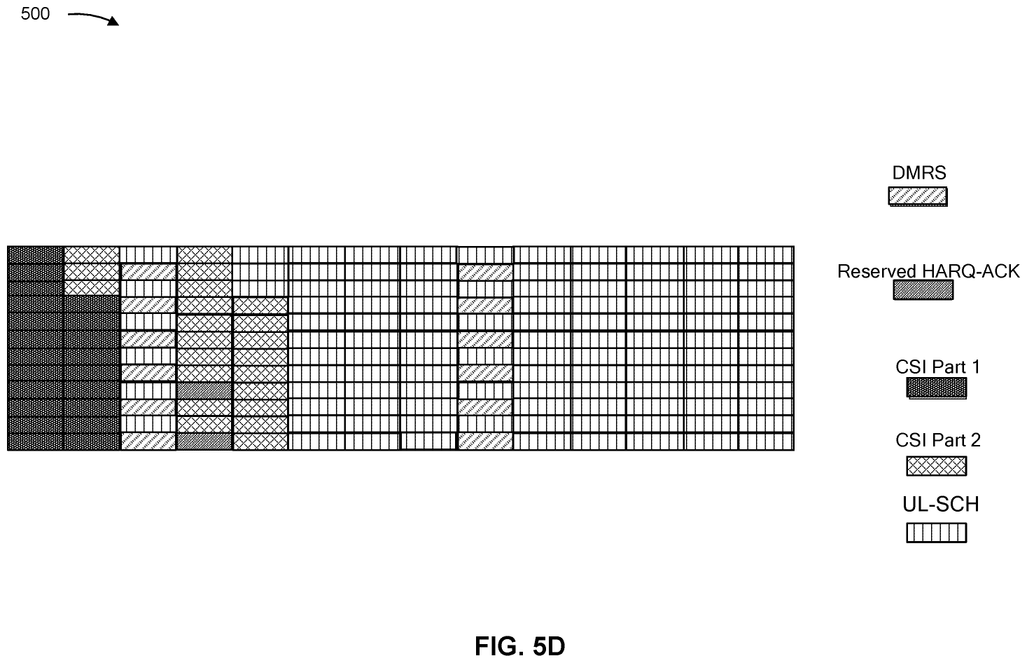

FIGS. 5A-5D are diagrams illustrating examples 500 of a UCI multiplexing with a PUSCH, in accordance with the present disclosure.

As shown in FIG. 5A, when a number of HARQ-ACK bits is not greater than two (e.g., the number of HARQ-ACK bits is less than or equal to two), a UE may find reserved HARQ-ACK locations, and the UE may mark the reserved HARQ-ACK locations on a grid. The grid may be associated with a physical resource block (PRB). The grid (or PRB) may be associated with 12 subcarriers in an FD and 14 symbols in a TD. The grid may be associated with DMRS locations. As shown in FIG. 5B, the UE may find REs for coded CSI part 1 bits and coded CSI part 2 bits. As shown in FIG. 5C, the UE may find REs for coded UL-SCH data bits. As shown in FIG. 5D, when the number of HARQ-ACK bits is less than or equal to two, the UE may find REs for coded HARQ-ACK bits (e.g., using puncturing).

As indicated above, FIGS. 5A-5D are provided as examples. Other examples may differ from what is described with regard to FIGS. 5A-5D.

UCI may be multiplexed with a PUSCH, but a UCI multiplexing with the PUSCH may not create repetition in an FD or in a TD. The UCI multiplexing with the PUSCH may not be done in accordance with a repetition pattern, such that a DMRS, a reserved HARQ-ACK, a CSI part 1, a CSI part 2, and/or a UL-SCH may not be repeated in a PRB. Without repetition for the PUSCH, no OCC may be applied to the PUSCH because OCC may need to be applied to repeated bits. For example, for a given UE, an OCC of +1 or −1 may be applied to repeated modulated symbols. However, with no repetition, the OCC may be unable to be applied to the PUSCH. When the OCC is not applied to the PUSCH, multiple users cannot be multiplexed using OCC, which would otherwise increase a system capacity.

In various aspects of techniques and apparatuses described herein, a UE may create repetition during a UCI multiplexing with a PUSCH. The UE may repeat a DMRS, a reserved HARQ-ACK, a CSI part 1, a CSI part 2, and/or a UL-SCH in one or more PRBs associated with the UCI multiplexing with the PUSCH. One PRB may be associated with 12 subcarriers in an FD and 14 symbols in a TD. The PUSCH may be partitioned into a number of subsets, depending on a number of users (or UEs). The UE may create a mapping of UCI bits and UL-SCH bits in a subset of the PUSCH, and then the UE may copy the mapping of UCI bits and UL-SCH bits to one or more remaining subsets of the PUSCH, thereby resulting in the repetition of the reserved HARQ-ACK, the CSI part 1, the CSI part 2, and/or the UL-SCH. The UE may modulate UCI bits and UL-SCH bits to symbols (e.g., quadrature amplitude modulation (QAM) symbols in a QAM constellation of size 4) on the resource elements of the PUSCH. An OCC may be applied to each subset of the PUSCH. For example, the UE may apply an OCC of +1 and +1 to subsets associated with the PUSCH, respectively. Another UE may apply an OCC of +1 and −1 to subsets associated with the PUSCH, respectively. Thus, a repetition pattern may be created in the FD or in the TD, which may allow for the OCC to be applied to a whole PUSCH. A network node may separate signals from different UEs based on the OCC being applied to the whole PUSCH. In other words, same OCC patterns may be generated using repetition, which may allow the network node to separate signals from different UEs.

In some aspects, an OCC may have a code length of one (e.g., a spreading factor may equal one) (e.g., no OCC is applied), which may be a special case of OCC.

In some aspects, by creating repetition during the UCI multiplexing with the PUSCH in accordance with a repetition pattern, OCC may be applied to the PUSCH. The OCC may allow multiple users to be multiplexed. For example, an FD OCC may double a number of supported UEs. When communications associated with multiple UEs are multiplexed using OCC, an overall system capacity may be increased because more UEs may be supported with same amount of resources, as compared to no multiplexing of multiple users using OCC. The repetition pattern may allow the OCC to be applied, which may allow the multiple users to be multiplexed using the same amount of resources, thereby improving the system capacity. When a bandwidth is limited, the repetition pattern may enable an ability to multiplex the multiple users using the same amount of resources, which may improve an overall system performance.

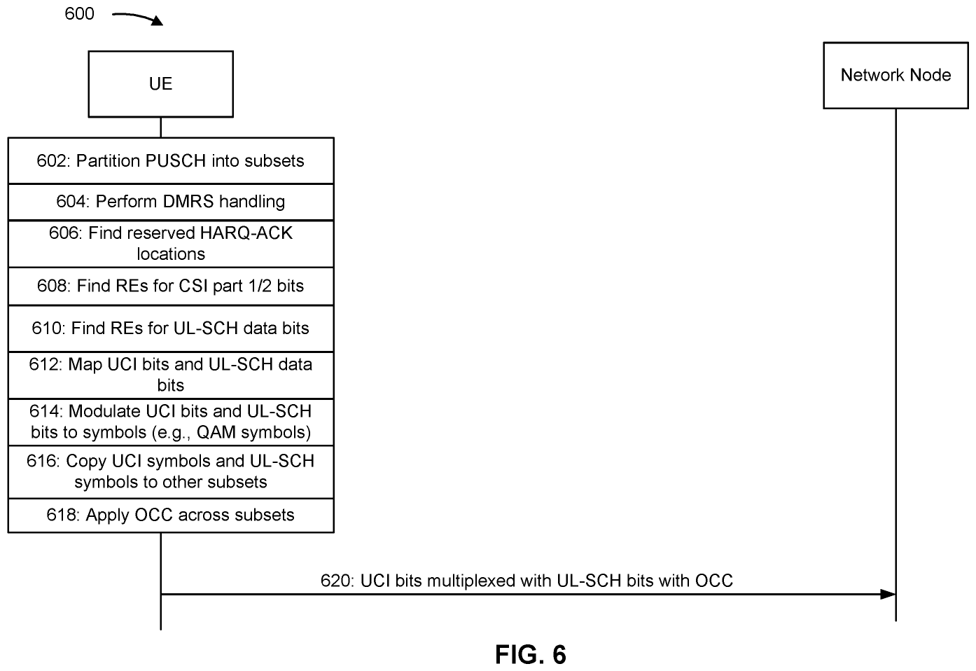

FIG. 6 is a diagram illustrating an example 600 associated with OCC for UCI multiplexing with PUSCH, in accordance with the present disclosure. As shown in FIG. 6, example 600 includes communication between a UE (e.g., UE 120) and a network node (e.g., network node 110). In some aspects, the UE and the network node may be included in a wireless network, such as wireless network 100.

As shown by reference number 602, the UE may partition a PUSCH into a plurality of subsets of resources. The UE may partition the PUSCH based at least in part on signaling from the network node. Alternatively, the UE may partition the PUSCH based at least in part on a specification (e.g., the UE may be preconfigured to partition the PUSCH in a certain manner known to the network). In some aspects, subcarriers allocated to the PUSCH may be partitioned into the plurality of subsets of resources. A first subset of resources may be associated with a plurality of contiguous subcarriers or a plurality of non-contiguous subcarriers. The first subset of resources may be associated with a comb of subcarriers (of a plurality of subcarriers). A comb, such as one out of every two subcarriers at an OFDM symbol, may be a special form of a non-contiguous pattern. In some aspects, symbols allocated to the PUSCH may be partitioned into the plurality of subsets of resources. The first subset of resources may be associated with a plurality of contiguous symbols or a plurality of non-contiguous symbols. The first subset of resources may be associated with a comb of symbols (of a plurality of symbols, where the symbols may be OFDM symbols or DFT-s-OFDM symbols). In some aspects, slots allocated to the PUSCH may be partitioned into the plurality of subsets of resources. The first subset of resources may be associated with a plurality of contiguous slots or a plurality of non-contiguous slots. The first subset of resources may be associated with a comb of slots (of a plurality of slots).

As shown by reference number 604, the UE may perform a DMRS handling. In some aspects, one or more DMRS symbols may be excluded from an OCC. No UCI bits or UL-SCH data bits may be mapped to one or more unused REs (e.g., unused by DMRS) of a symbol occupied by DMRS. The UCI bits or the UL-SCH data bits may be excluded from being mapped to one or more unused REs of the symbol occupied by DMRS. In some aspects, DMRS symbols may be included for the OCC. The UL-SCH data bits may be mapped to one or more unused REs of the symbol occupied by DMRS. In some aspects, DMRS symbols may be excluded from the OCC, and no DMRS symbols may be included in the plurality of subsets of resources. In some aspects, DMRS symbols may be included for the OCC, and at least one of the DMRS symbols does not fall within the first subset of resources. In other words, at least one of the DMRS symbols may be excluded from the first subset of resources. In this example, one or more DMRS REs in a symbol of a comb that is nearest to a DMRS symbol, in relation to other DMRS REs, may be marked as unavailable (or not available), or alternatively, information associated with a DMRS RE may be copied to a symbol in a comb that is nearest to a DMRS symbol, in relation to other DMRS symbols. In some aspects, one or more unused REs on DMRS symbols may be used for the UL-SCH data bits with the OCC, and the DMRS symbols may fall into the first subset of resources. In some aspects, unused REs on DMRS symbols may be used for the UL-SCH data bits with the OCC, and a portion of DMRS symbols may fall outside of the first subset of resources.

As shown by reference number 606, the UE may find reserved HARQ-ACK locations and mark the reserved HARQ-ACK locations on a grid. The grid may be associated with a PRB. The grid (or PRB) may be associated with 12 subcarriers in an FD and 14 symbols in a TD. As shown by reference number 608, the UE may find REs for coded CSI part 1 bits and coded CSI part 2 bits. As shown by reference number 610, the UE may find REs for coded UL-SCH data bits.

As shown by reference number 612, the UE may map UCI bits and UL-SCH data bits to the first subset of resources associated with the PUSCH. The UE may map the UCI bits and the UL-SCH data bits by reading bits in an FD, followed by a TD, at each RE other than DM-RS REs. The UCI bits may include HARQ-ACK bits, CSI part 1 bits, and CSI part 2 bits.

As shown by reference number 614, the UE may scramble the UCI bits and the UL-SCH data bits that are mapped to the first subset of resources associated with the PUSCH. In some aspects, the scrambled bits may go through further processing to generate modulated symbols that are subsequently mapped to the first subset of resources associated with the PUSCH. The further processing may include modulation, layer mapping, transform precoding and precoding, and may result in modulated symbols. In some aspects, by modulation, the scrambled bits may be mapped to symbols drawn from a QAM constellation. In some aspects, the UCI bits and the UL-SCH data bits that are mapped to the first subset of resources associated with the PUSCH and the UCI bits and UL-SCH data bits that are mapped to the other subsets of resources associated with the PUSCH may go through the same scrambling and the same further processing.

As shown by reference number 616, the UE may copy the symbols corresponding to the UCI bits and the UL-SCH data bits from the first subset of resources to one or more remaining subsets of resources associated with the PUSCH, to obtain copied symbols, based at least in part on a repetition pattern. The UE may repeat or copy a mapping of the symbols corresponding to the UCI bits and the UL-SCH data bits in the one or more remaining subsets of resources associated with the PUSCH based at least in part on the repetition pattern. The UE may copy the modulated symbols corresponding to the UCI bits and the UL-SCH data bits to subsets across an FD or a TD, depending on the repetition pattern.

As shown by reference number 618, the UE may apply an OCC across a plurality of subsets of resources, which may include the first subset of resources and the one or more remaining subsets of resources, associated with the PUSCH based at least in part on the repetition pattern. The OCC may be an FD OCC applied by multiplying an OCC codeword across the plurality of subsets of resources. The OCC may be a symbol-level (e.g., the symbol being an OFDM symbol) OCC applied by multiplying, in a TD, an OCC codeword across the plurality of subsets of resources. The OCC may be a slot-level OCC applied by multiplying, in the TD, an OCC codeword across the plurality of subsets of resources. In some aspects, different UEs may apply different OCCs to the plurality of subsets of resources. For example, a first UE may apply an OCC of [+1 +1], whereas a second UE may apply an OCC of [+1 −1], which may create orthogonality between the first UE and the second UE.

As shown by reference number 620, the UE may transmit, to the network node and based at least in part on the OCC applied across the plurality of subsets of resources, multiplexed UCI bits and UL-SCH data bits. The multiplexed UCI bits and UL-SCH data bits may be based at least in part on symbols associated with the UCI bits and the UL-SCH bits associated with the first subset of resources and the copied symbols associated with the UCI bits and the

UL-SCH data bits associated with the one or more remaining subsets of resources. Since different UEs may apply different OCCs, the network node may be able to separate multiplexed PUSCHs from the different UEs. In some aspects, the multiplexed UCI bits and UL-SCH data bits may be associated with multiple OCC schemes in FD and/or in the TD. The OCC may be associated with the multiple OCC schemes, which may be simultaneously applied in the FD and in the TD. Further, a number of REs for the multiplexed UCI bits and UL-SCH data bits may be based at least in part on a spreading factor for the PUSCH, and the spreading factor may be based at least in part on the repetition pattern.

As indicated above, FIG. 6 is provided as an example. Other examples may differ from what is described with regard to FIG. 6.

In some aspects, a UCI multiplexing with a PUSCH may be associated with FD OCC. Subcarriers allocated to the PUSCH may be partitioned into a number of subsets (e.g., F subsets). A subset may include contiguous subcarriers, or the subset may be a comb of subcarriers (of all subcarriers). The PUSCH may be associated with one or more PRBs. A UE may perform a mapping of UCI bits and UL-SCH bits in a first subset (e.g., subset 0).

In some aspects, the UE may handle DMRS symbols in accordance with a first option or a second option. In the first option, DMRS symbols may be excluded from OCC. For example, no UCI bits or UL-SCH bits may be mapped to unused REs of a symbol occupied by DMRS. In the second option, DMRS symbols may be included for OCC. For example, UL-SCH bits may be mapped to unused REs of a symbol occupied by DMRS.

In some aspects, when a number of HARQ-ACK bits is less than or equal to two, the UE may find reserved HARQ-ACK locations and mark the reserved HARQ-ACK locations on a grid. When the number of HARQ-ACK bits is greater than two, the UE may find resource elements (REs) for coded HARQ-ACK bits. The UE may find REs for CG-UCI bits when CG-UCI is present for transmission on the PUSCH without HARQ-ACK. The UE may find REs for coded CSI part 1 bits and coded CSI part 2 bits. The UE may find REs for coded uplink shared channel (UL-SCH) data bits. When a number of HARQ-ACK bits is less than or equal to two, the UE may find REs for the coded HARQ-ACK bits (e.g., using puncturing). The UE may map UCI bits and the UL-SCH data bits by reading bits in an FD, followed by a TD, at each RE other than DM-RS REs. The UE may copy the mapping of UCI bits and UL-SCH bits in the first subset to other subsets (e.g., F−1 subsets). The UE may apply OCC by multiplying an OCC codeword across the subsets (e.g., across the F subsets).

In some aspects, the OCC may include a sub-PRB OCC as a special case. For example, some entries in an OCC code may be zero, whereas other entries in an OCC code may be one. When OCC is applied before transform precoding (e.g., DFT spreading), a precoded PUSCH may occupy a comb in the FD.

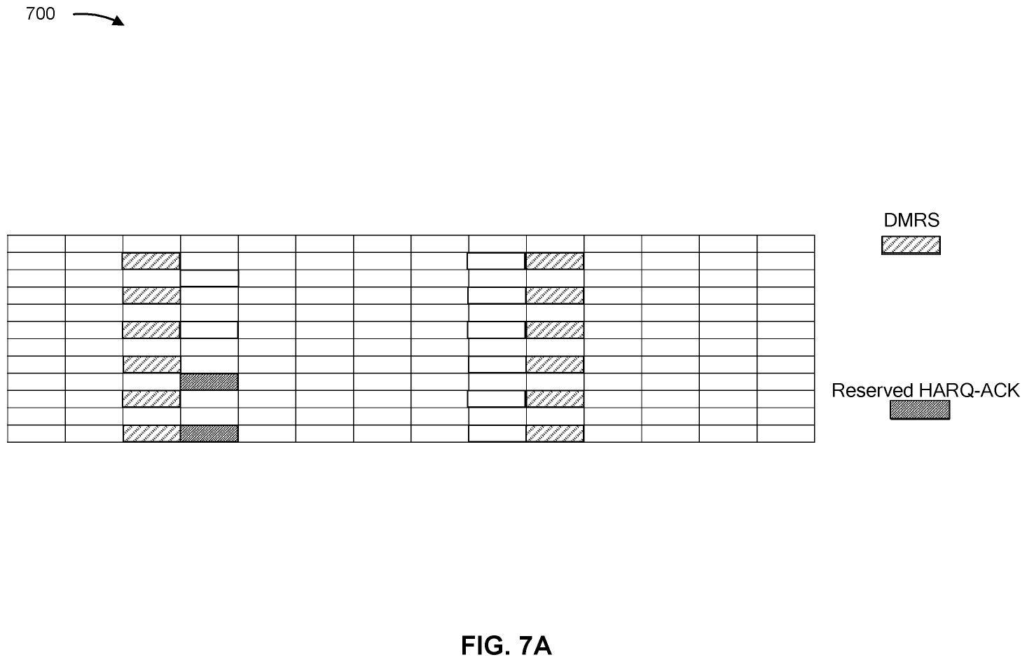

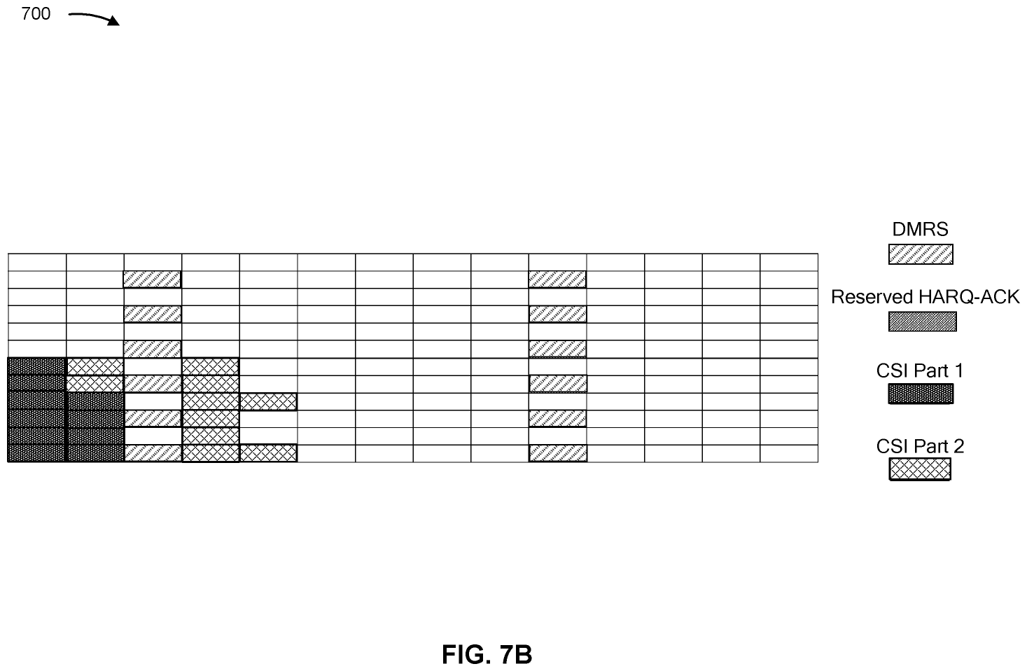

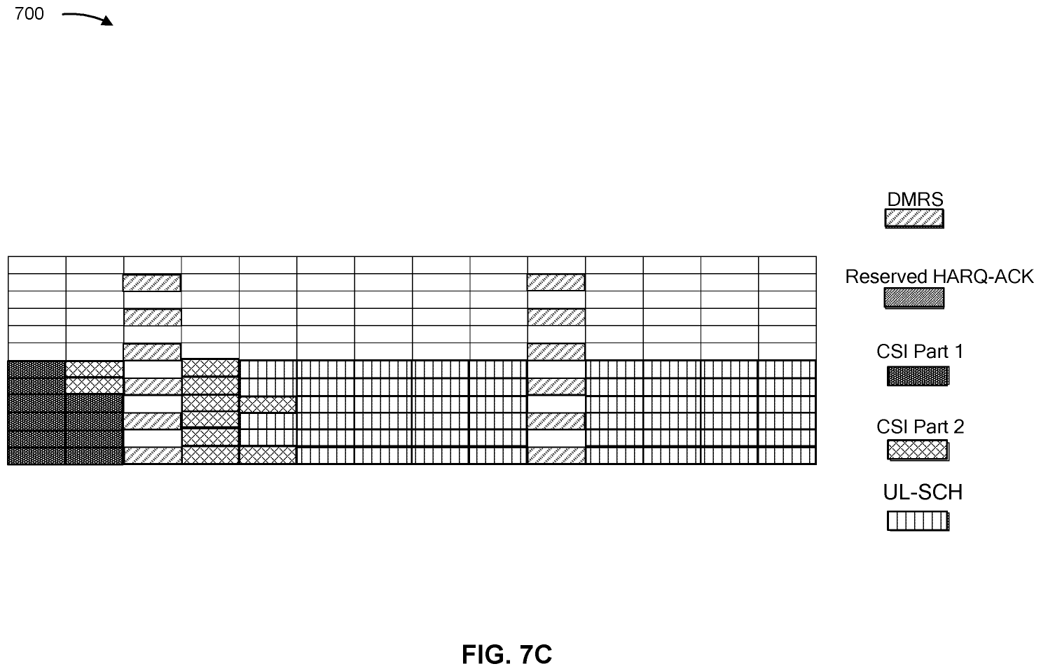

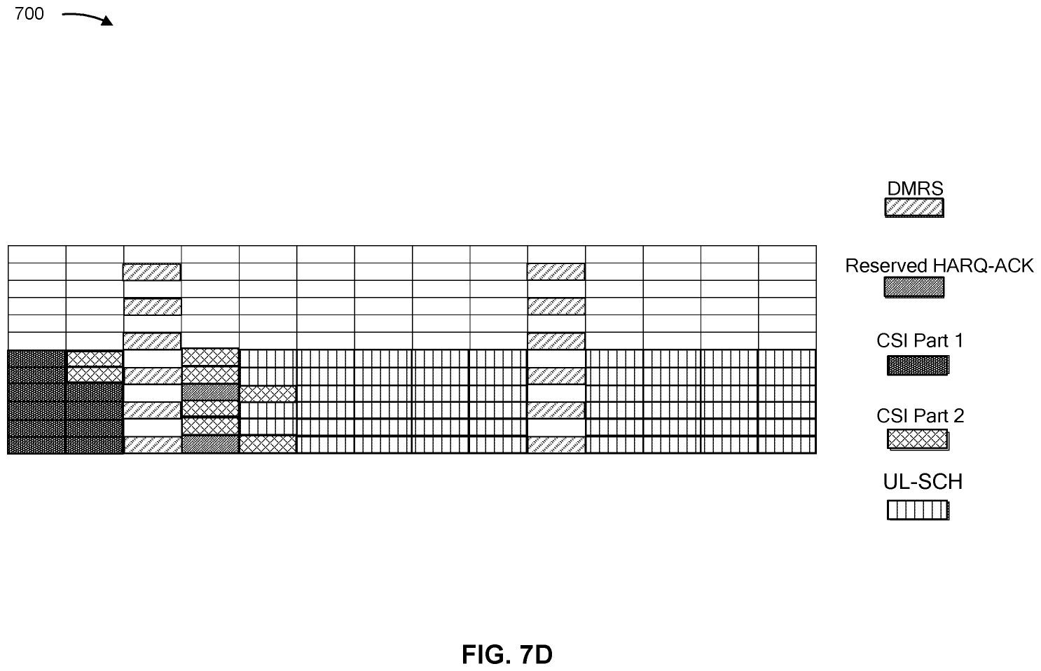

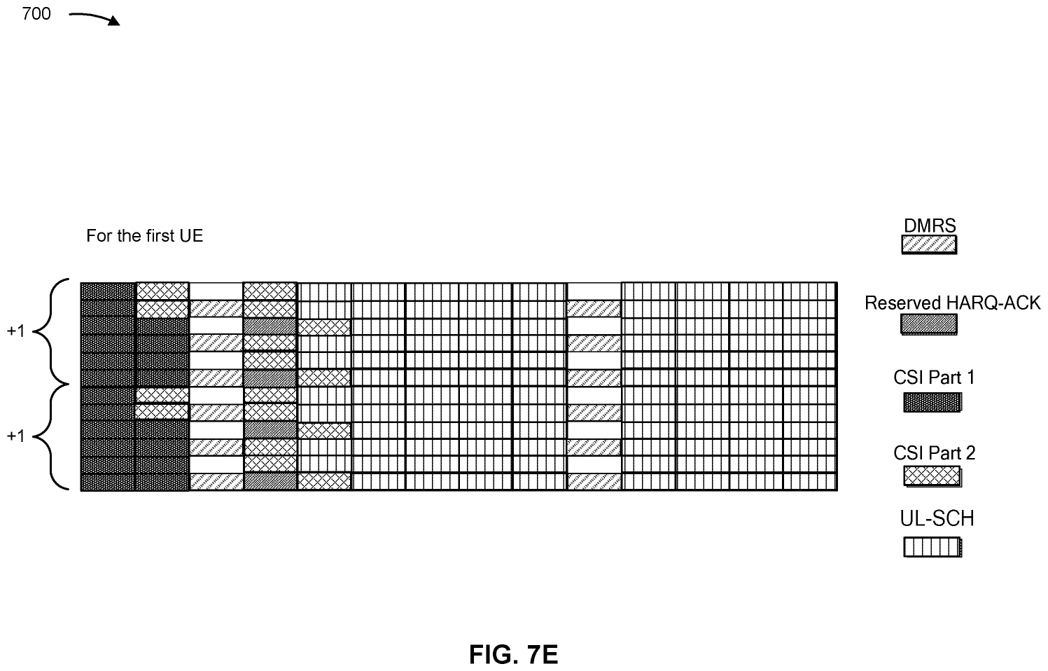

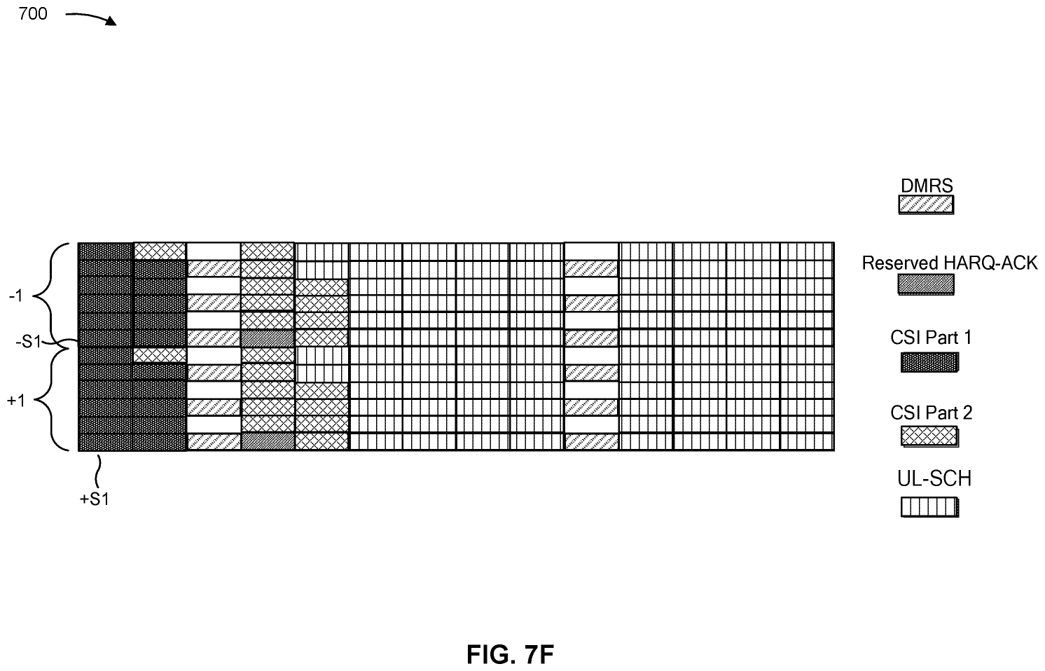

FIGS. 7A-7F are diagrams illustrating examples 700 associated with OCC for UCI multiplexing with PUSCH, in accordance with the present disclosure.

As shown in FIG. 7A, when a number of HARQ-ACK bits is not greater than two (e.g., the number of HARQ-ACK bits is less than or equal to two), and when DMRS symbols are excluded from OCC, a UE, such as a first UE or a second UE, may find reserved HARQ-ACK locations, and the UE may mark the reserved HARQ-ACK locations on a grid. The grid may be associated with DMRS locations. As shown in FIG. 7B, the UE may find REs for coded CSI part 1 bits and coded CSI part 2 bits. As shown in FIG. 7C, the UE may find REs for coded UL-SCH data bits. As shown in FIG. 7D, when the number of HARQ-ACK bits is less than or equal to two, the UE may find REs for coded HARQ-ACK bits (e.g., using puncturing). The UE may map UCI bits and UL-SCH data bits by reading bits in an FD, followed by a TD, at each RE other than DM-RS REs. The UE may copy the mapping of UCI bits and UL-SCH bits in a first subset to other subsets (e.g., F−1 subsets). The UE may apply OCC by multiplying an OCC codeword across subsets (e.g., across F subsets).

As shown in FIG. 7E, a mapping of UCI bits and UL-SCH data bits may be derived by the first UE, and a copy of the mapping may be derived by the first UE. The first UE may apply an OCC of +1 to the mapping of UCI bits and UL-SCH data bits. The first UE may apply an OCC of +1 to the copy of the mapping. As shown in FIG. 7F, a mapping of UCI bits and UL-SCH data bits may be derived by the second UE, and a copy of the mapping may be derived by the second UE. The second UE may apply an OCC of −1 to the mapping of UCI bits and UL-SCH data bits. The second UE may apply an OCC of +1 to the copy of the mapping. For example, −S1 may refer to an OCC of −1 that is applied to a symbol S, and +S1 may refer to an OCC of +1 that is applied to the symbol S.

As indicated above, FIGS. 7A-7F are provided as examples. Other examples may differ from what is described with regard to FIGS. 5A-5D.

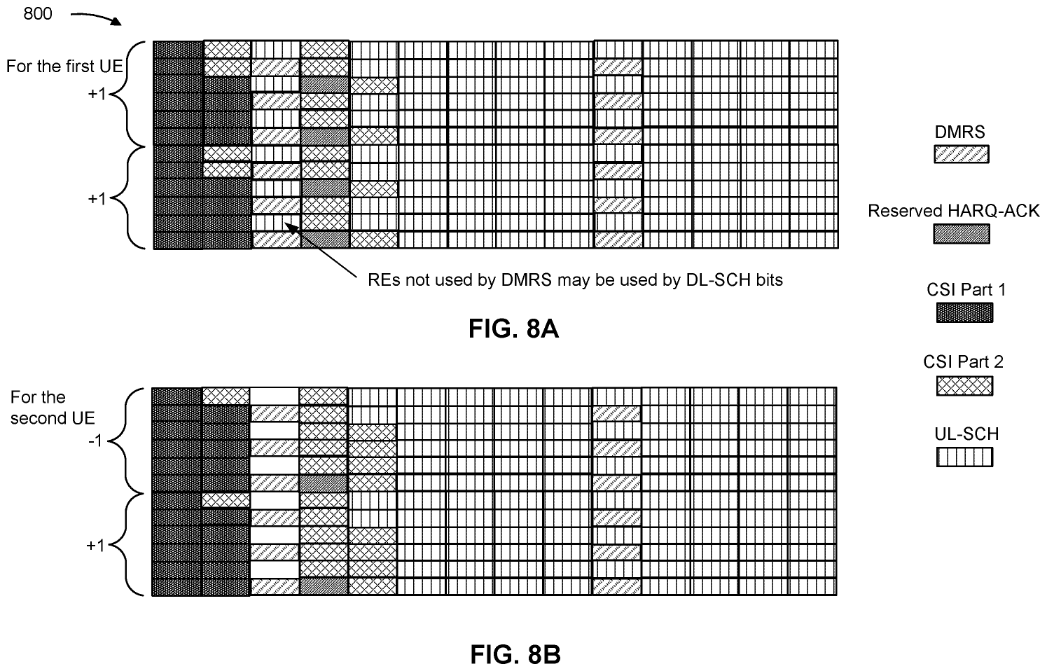

FIGS. 8A-8B are diagrams illustrating examples 800 associated with OCC for UCI multiplexing with PUSCH, in accordance with the present disclosure.

In some aspects, when a number of HARQ-ACK bits is less than or equal to two, and when DMRS symbols are included for OCC, a UE, such as a first UE or a second UE, may find reserved HARQ-ACK locations, and the UE may mark the reserved HARQ-ACK locations on a grid. The UE may find REs for coded CSI part 1 bits and coded CSI part 2 bits. The UE may find REs for coded UL-SCH data bits. When the number of HARQ-ACK bits is less than or equal to two, the UE may find REs for coded HARQ-ACK bits (e.g., using puncturing). The UE may map UCI bits and UL-SCH data bits by reading bits in an FD, followed by a TD, at each RE other than DM-RS REs. The UE may copy the mapping of UCI bits and UL-SCH bits in a first subset to other subsets (e.g., F−1 subsets). The UE may apply OCC by multiplying an OCC codeword across subsets (e.g., across F subsets).

As shown in FIG. 8A, a mapping of UCI bits and UL-SCH data bits may be derived by the first UE, and a copy of the mapping may be derived by the first UE. The first UE may apply an OCC of +1 to the mapping of UCI bits and UL-SCH data bits. The first UE may apply an OCC of +1 to the copy of the mapping. In this example, DMRS symbols may be included for OCC. REs not used by DMRS may be used by DL-SCH bits. As shown in FIG. 8B, a mapping of UCI bits and UL-SCH data bits may be derived by the second UE, and a copy of the mapping may be derived by the second UE. The second UE may apply an OCC of −1 to the mapping of UCI bits and UL-SCH data bits. The second UE may apply an OCC of +1 to the copy of the mapping.

As indicated above, FIGS. 8A-8B are provided as examples. Other examples may differ from what is described with regard to FIGS. 8A-8B.

In some aspects, a UCI multiplexing with a PUSCH may be associated with symbol-level OCC (e.g., TD OCC). Symbols allocated to the PUSCH may be partitioned into a number of subsets (e.g., T subsets). A subset may include contiguous symbols, or the subset may be a comb of symbols. The PUSCH may be associated with one or more PRBs. A UE may perform a mapping of UCI bits and UL-SCH bits in a first subset (e.g., subset 0).

In some aspects, the UE may handle DMRS symbols in accordance with a first option or a second option. In the first option, DMRS symbols may be excluded from OCC. For example, the DMRS symbols may not be included in any subset. In the second option, DMRS symbols may be included for OCC (e.g., when DMRS symbols do not fall within a first subset). In a first alternative, the UE may find a symbol in a comb that is nearest to a DMRS symbol. When two DMRS symbols are present, a DMRS symbol with a smaller symbol index, in relation to the other DMRS symbol, may be selected. DMRS REs in the DMRS symbol may be marked as not available, and such unavailability may be applied to other symbols during a copying. In a second alternative, a UE may find a symbol in a comb that is nearest to a DMRS symbol, and the UE may copy DMRS REs to the symbol.

In some aspects, when a number of HARQ-ACK bits is less than or equal to two, the UE may find reserved HARQ-ACK locations and mark the reserved HARQ-ACK locations on a grid. When the number of HARQ-ACK bits is greater than two, the UE may find resource elements (REs) for coded HARQ-ACK bits. The UE may find REs for CG-UCI bits when CG-UCI is present for transmission on the PUSCH without HARQ-ACK. The UE may find REs for coded CSI part 1 bits and coded CSI part 2 bits. The UE may find REs for coded uplink shared channel (UL-SCH) data bits. When a number of HARQ-ACK bits is less than or equal to two, the UE may find REs for the coded HARQ-ACK bits (e.g., using puncturing). The UE may map UCI bits and the UL-SCH data bits by reading bits in an FD, followed by a TD, at each RE other than DM-RS REs. The UE may copy the mapping of UCI bits and UL-SCH bits in the first subset to other subsets (e.g., T−1 subsets). The UE may apply OCC by multiplying an OCC codeword across the subsets (e.g., across the T subsets).

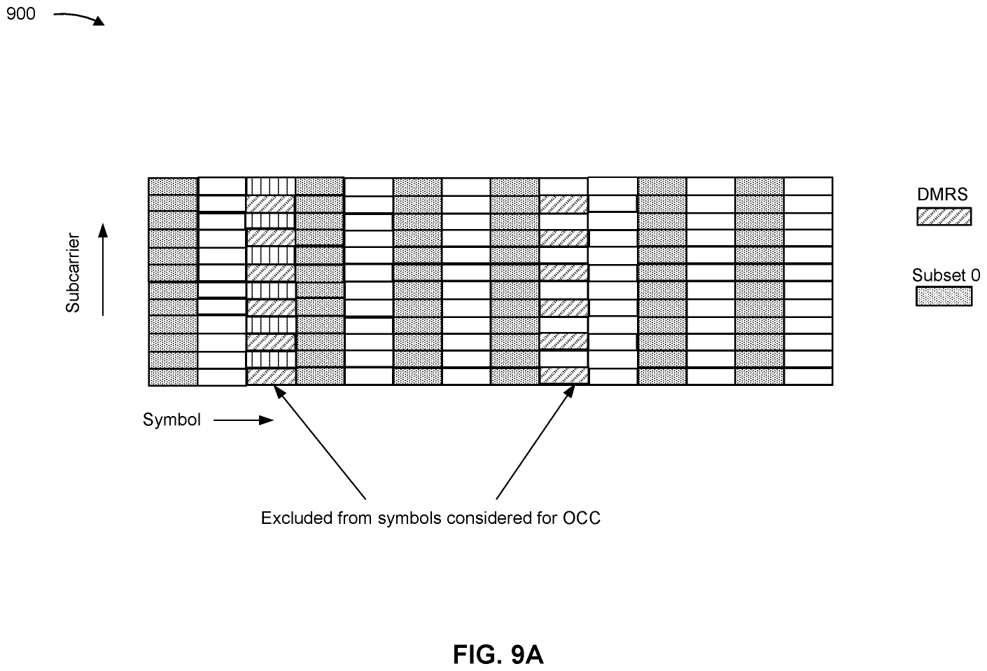

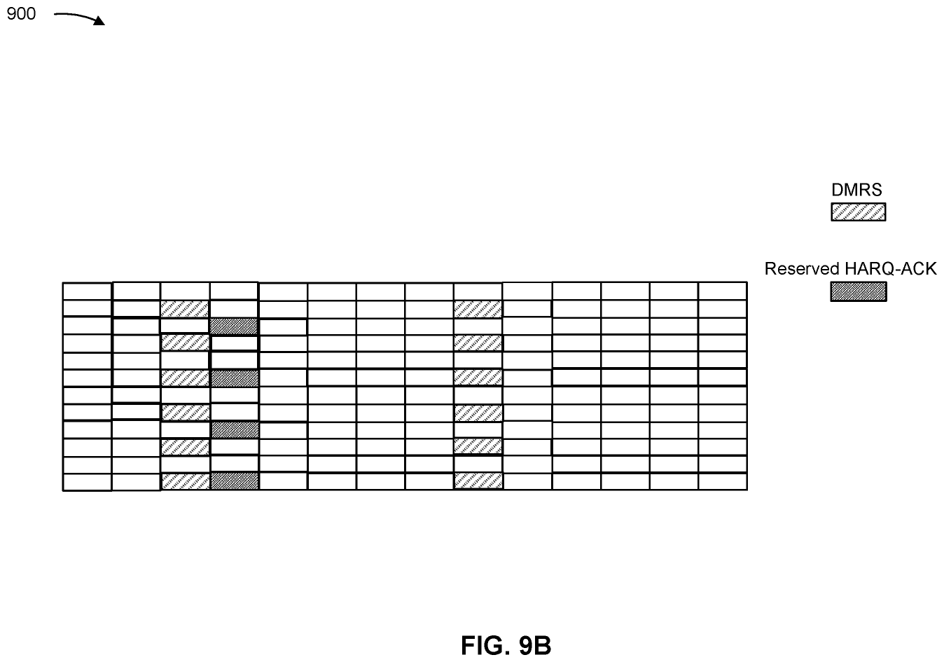

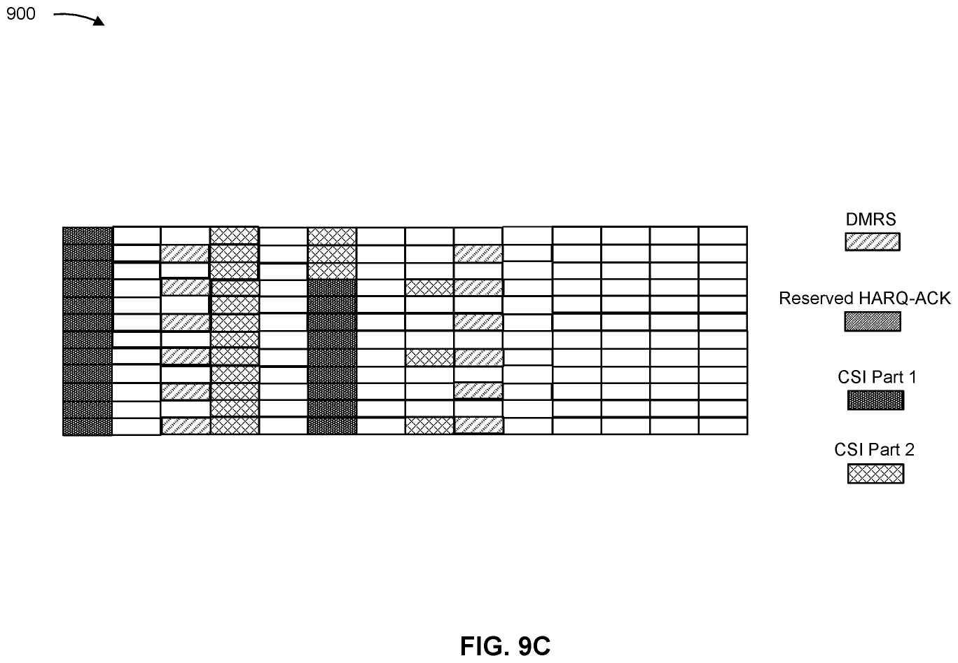

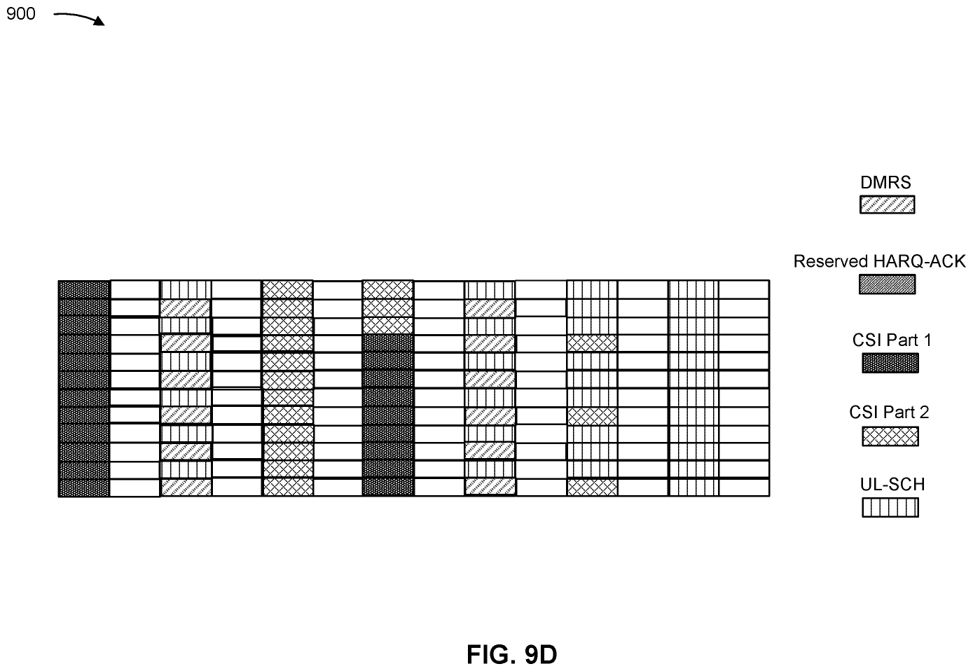

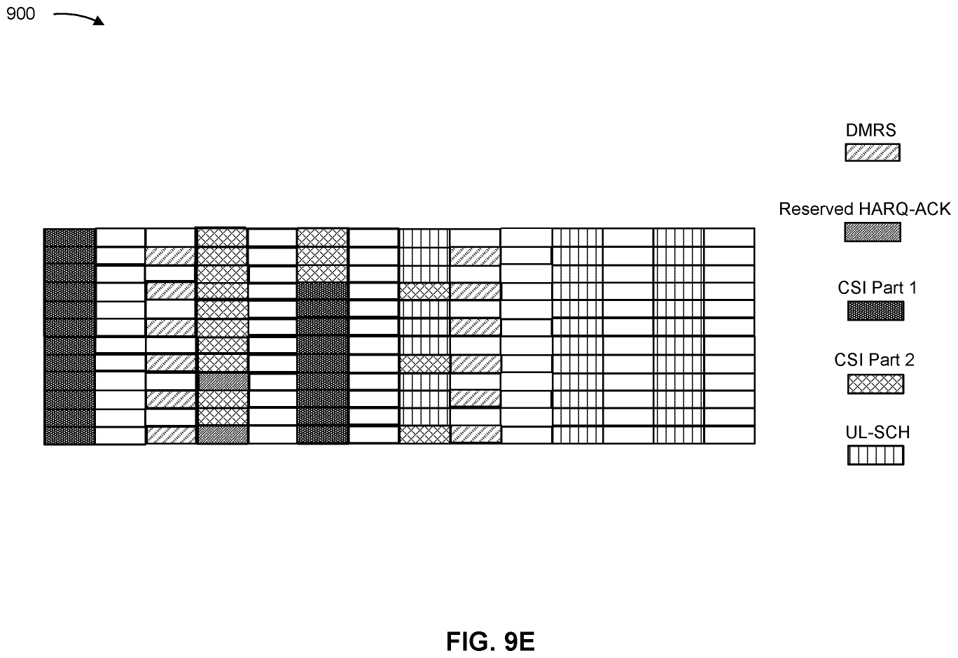

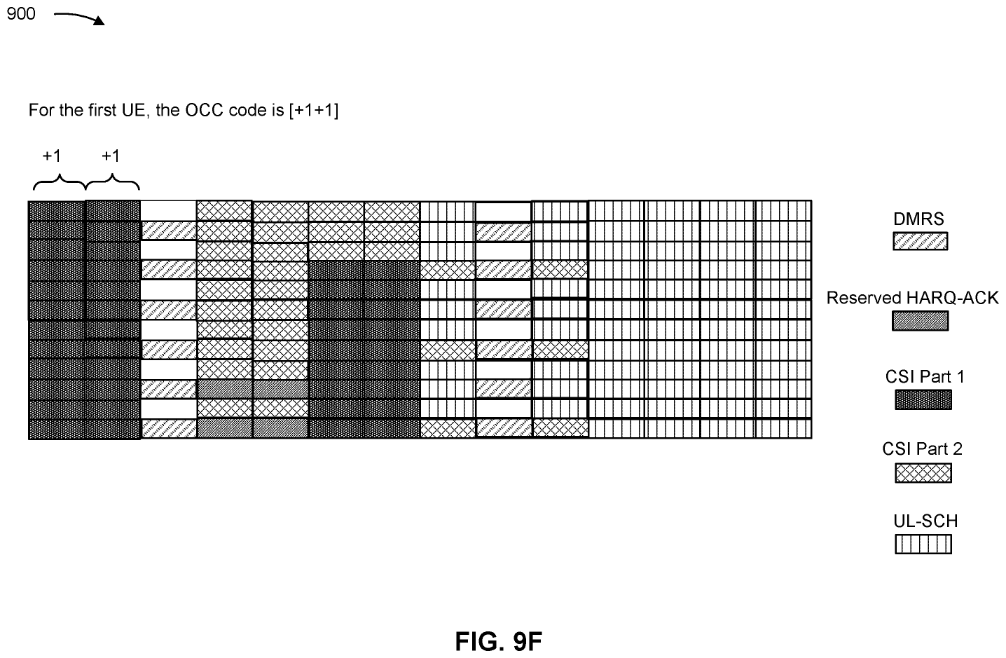

FIGS. 9A-9G are diagrams illustrating examples 900 associated with OCC for UCI multiplexing with PUSCH, in accordance with the present disclosure.

In some aspects, a number of HARQ-ACK bits may not be greater than two. Symbols allocated to a PUSCH may be partitioned into a number of subsets (e.g., T subsets). A subset may include contiguous symbols, or the subset may be a comb of symbols. As shown in FIG. 9A, DMRS symbols may be excluded from OCC. In other words, DMRS symbols may be excluded from symbols considered for OCC. The number of subsets may include a first subset, such as subset 0. As shown in FIG. 9B, when a number of HARQ-ACK bits is less than or equal to two, a UE, such as a first UE or a second UE, may find reserved HARQ-ACK locations, and the UE may mark the reserved HARQ-ACK locations on a grid. The grid may be associated with DMRS locations. As shown in FIG. 9C, the UE may find REs for coded CSI part 1 bits and coded CSI part 2 bits. As shown in FIG. 9D, the UE may find REs for coded UL-SCH data bits. As shown in FIG. 9E, when the number of HARQ-ACK bits is less than or equal to two, the UE may find REs for coded HARQ-ACK bits (e.g., using puncturing). The UE may map UCI bits and UL-SCH data bits by reading bits in an FD, followed by a TD, at each RE other than DM-RS REs. The UE may copy the mapping of UCI bits and UL-SCH bits in the first subset to other subsets (e.g., T−1 subsets). The UE may apply OCC by multiplying an OCC codeword across subsets (e.g., across T subsets).

As shown in FIG. 9F, a mapping of UCI bits and UL-SCH data bits may be derived by the first UE, and a copy of the mapping may be derived by the first UE. The first UE may apply an OCC of +1 to the mapping of UCI bits and UL-SCH data bits. The first UE may apply an OCC of +1 to the copy of the mapping. In other words, for the first UE, the OCC may be [+1 +1]. As shown in FIG. 9G, a mapping of UCI bits and UL-SCH data bits may be derived by the second UE, and a copy of the mapping may be derived by the second UE. The second UE may apply an OCC of +1 to the mapping of UCI bits and UL-SCH data bits. The second UE may apply an OCC of −1 to the copy of the mapping. In other words, for the second UE, the OCC may be [+1 −1].

As indicated above, FIGS. 9A-9G are provided as examples. Other examples may differ from what is described with regard to FIGS. 9A-9G.

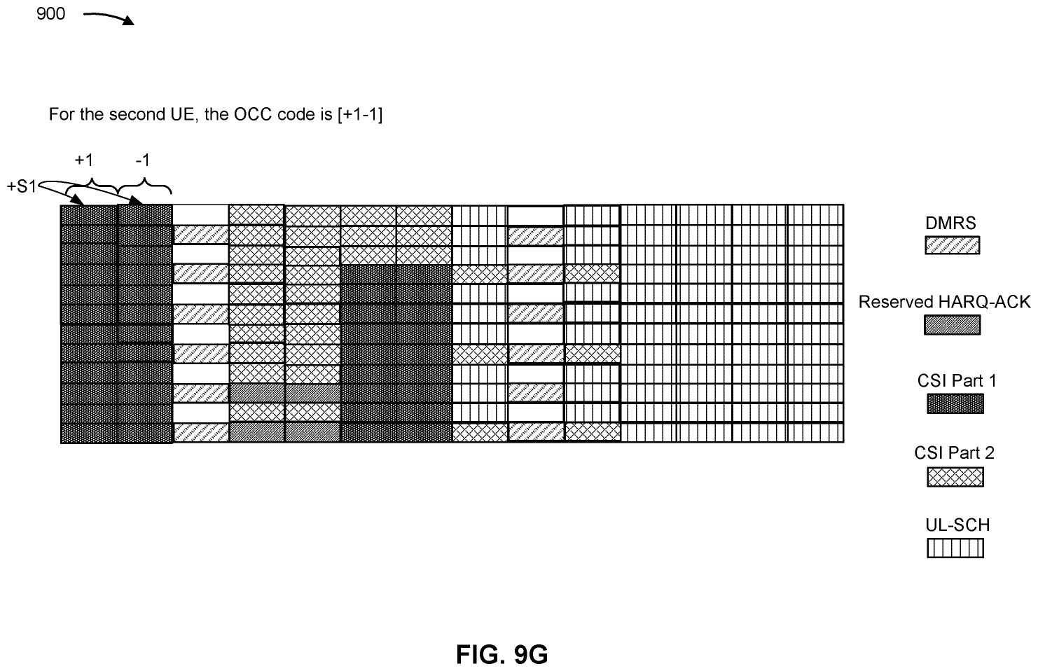

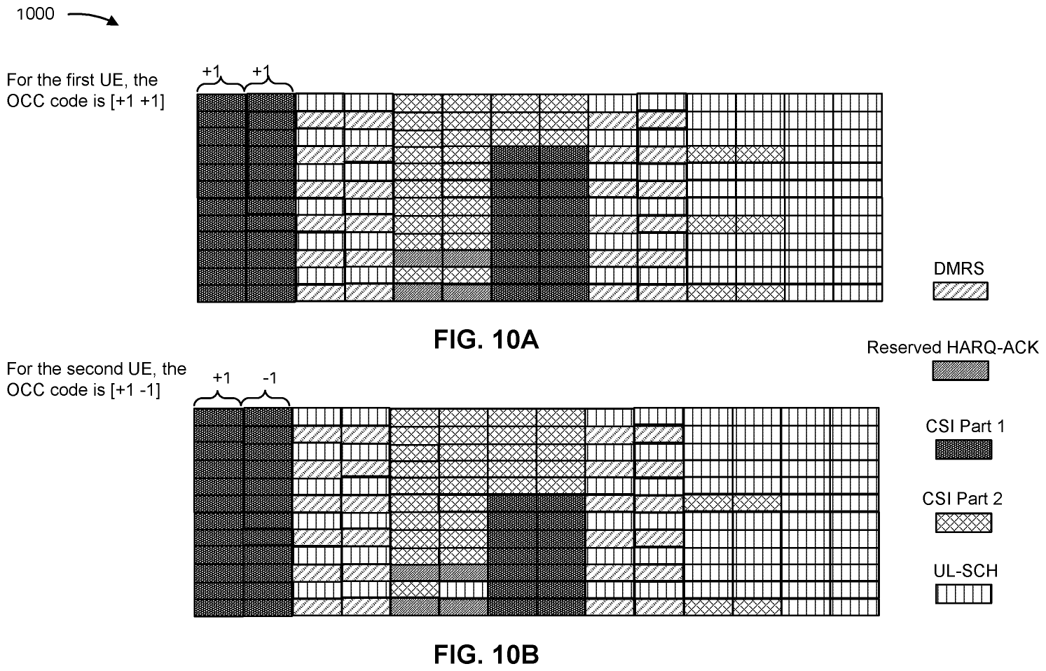

FIGS. 10A-10B are diagrams illustrating examples 1000 associated with OCC for UCI multiplexing with PUSCH, in accordance with the present disclosure.

In some aspects, a number of HARQ-ACK bits may not be greater than two. Symbols allocated to a PUSCH may be partitioned into a number of subsets (e.g., T subsets). A subset may include contiguous symbols, or the subset may be a comb of symbols. The number of subsets may include a first subset, such as subset 0. DMRS symbols may be included for OCC. In this example, unused REs on DMRS symbols may be used for UL-SCH bits with OCC, and a plurality of DMRS symbols (e.g., all DMRS symbols) may fall into the first subset.

In some aspects, when a number of HARQ-ACK bits is not greater than two (e.g., the number of HARQ-ACK bits is less than or equal to two), a UE, such as a first UE or a second UE, may find reserved HARQ-ACK locations, and the UE may mark the reserved HARQ-ACK locations on a grid. The UE may find REs for coded CSI part 1 bits and coded CSI part 2 bits. The UE may find REs for coded UL-SCH data bits. When the number of HARQ-ACK bits is less than or equal to two, the UE may find REs for coded HARQ-ACK bits (e.g., using puncturing). The UE may map UCI bits and UL-SCH data bits by reading bits in an FD, followed by a TD, at each RE other than DM-RS REs. The UE may copy the mapping of UCI bits and UL-SCH bits in a first subset to other subsets (e.g., T−1 subsets). The UE may apply OCC by multiplying an OCC codeword across subsets (e.g., across T subsets).

As shown in FIG. 10A, a mapping of UCI bits and UL-SCH data bits may be derived by the first UE, and a copy of the mapping may be derived by the first UE. The first UE may apply an OCC of +1 to the mapping of UCI bits and UL-SCH data bits. The first UE may apply an OCC of +1 to the copy of the mapping. In other words, for the first UE, the OCC may be [+1 +1]. As shown in FIG. 10B, a mapping of UCI bits and UL-SCH data bits may be derived by the second UE, and a copy of the mapping may be derived by the second UE. The second UE may apply an OCC of −1 to the mapping of UCI bits and UL-SCH data bits. The second UE may apply an OCC of +1 to the copy of the mapping. In other words, for the second UE, the OCC may be [+1 −1].

As indicated above, FIGS. 10A-10B are provided as examples. Other examples may differ from what is described with regard to FIGS. 10A-10B.

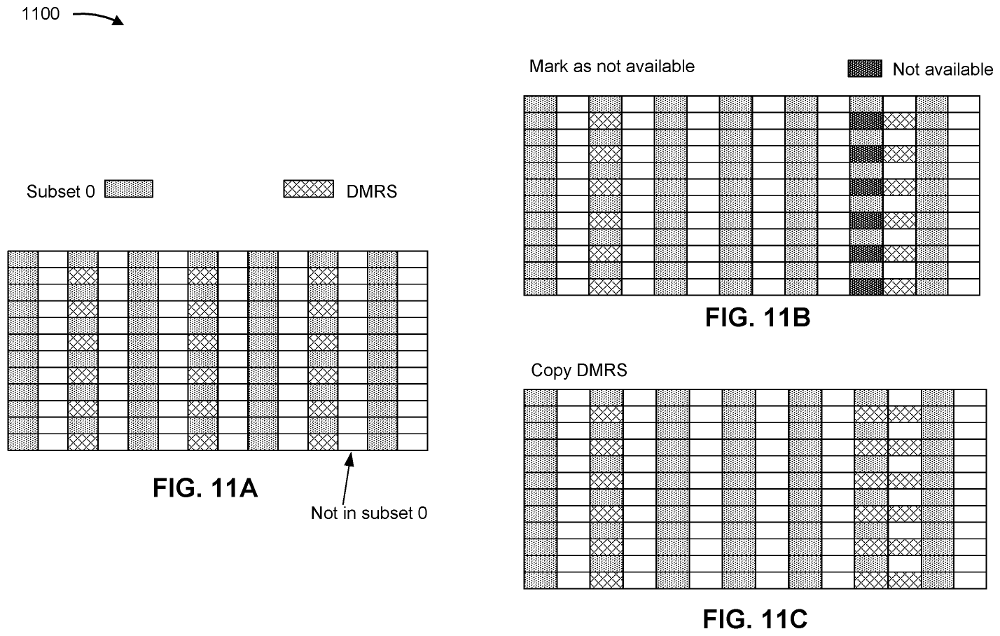

FIGS. 11A-11C are diagrams illustrating examples 1100 associated with OCC for UCI multiplexing with PUSCH, in accordance with the present disclosure.

In some aspects, a number of HARQ-ACK bits may not be greater than two. Symbols allocated to a PUSCH may be partitioned into a number of subsets (e.g., T subsets). A subset may include contiguous symbols, or the subset may be a comb of symbols. The number of subsets may include a first subset, such as subset 0. DMRS symbols may be included for OCC. In this example, unused REs on DMRS symbols may be used for UL-SCH bits with OCC, and not all DMRS symbols may fall into the first subset.

As shown in FIG. 11A, not all DMRS symbols may fall into the first subset (e.g., subset 0). Some DMRS symbols may fall outside of the first subset. As shown in FIG. 11B, a UE may find a symbol in a comb that is nearest to a DMRS symbol. When two DMRS symbols are present, a DMRS symbol with a smaller symbol index, in relation to the other DMRS symbol, may be selected. DMRS REs in the DMRS symbol may be marked as not available, and such unavailability may be applied to other symbols during a copying. As shown in FIG. 11C, a UE may find a symbol in a comb that is nearest to a DMRS symbol, and the UE may copy DMRS REs to the symbol.

As indicated above, FIGS. 11A-11C are provided as examples. Other examples may differ from what is described with regard to FIGS. 11A-11C.

In some aspects, a UCI multiplexing with a PUSCH may be associated with slot-level OCC (e.g., TD OCC). Slots allocated to a PUSCH with TBoMS may be partitioned into a number of subsets (e.g., S subsets) in a TD. A subset may include contiguous slots, or the subset may be a comb of slots. A UE may perform a mapping of UCI bits and UL-SCH bits in a first subset (e.g., subset 0).

In some aspects, when a number of HARQ-ACK bits is less than or equal to two, the UE may find reserved HARQ-ACK locations and mark the reserved HARQ-ACK locations on a grid. When the number of HARQ-ACK bits is greater than two, the UE may find resource elements (REs) for coded HARQ-ACK bits. The UE may find REs for CG-UCI bits when CG-UCI is present for transmission on the PUSCH without HARQ-ACK. The UE may find REs for coded CSI part 1 bits and coded CSI part 2 bits. The UE may find REs for coded uplink shared channel (UL-SCH) data bits. When a number of HARQ-ACK bits is less than or equal to two, the UE may find REs for the coded HARQ-ACK bits (e.g., using puncturing). The UE may map UCI bits and the UL-SCH data bits by reading bits in an FD, followed by a TD, at each RE other than DM-RS REs. The UE may copy the mapping of UCI bits and UL-SCH bits in the first subset to other subsets (e.g., S−1 subsets). The UE may apply OCC by multiplying an OCC codeword across the subsets (e.g., across the S subsets).

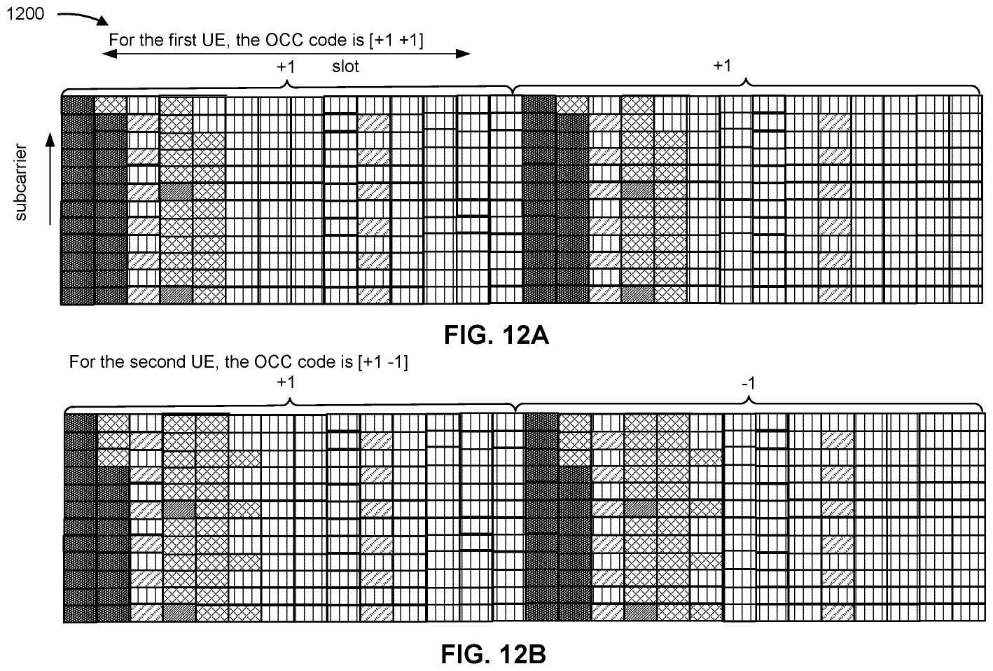

FIGS. 12A-12B are diagrams illustrating examples 1200 associated with OCC for UCI multiplexing with PUSCH, in accordance with the present disclosure.

In some aspects, slots allocated to a PUSCH with TBoMS may be partitioned into a number of subsets (e.g., S subsets) in a TD. A subset may include contiguous slots, or the subset may be a comb of slots. When a number of HARQ-ACK bits is less than or equal to two, and when DMRS symbols are included for OCC, a UE, such as a first UE or a second UE, may find reserved HARQ-ACK locations, and the UE may mark the reserved HARQ-ACK locations on a grid. The UE may find REs for coded CSI part 1 bits and coded CSI part 2 bits. The UE may find REs for coded UL-SCH data bits. When the number of HARQ-ACK bits is less than or equal to two, the UE may find REs for coded HARQ-ACK bits (e.g., using puncturing). The UE may map UCI bits and UL-SCH data bits by reading bits in an FD, followed by a TD, at each RE other than DM-RS REs. The UE may copy the mapping of UCI bits and UL-SCH bits in a first subset to other subsets (e.g., S−1 subsets). The UE may apply OCC by multiplying an OCC codeword across subsets (e.g., across S subsets).

As shown in FIG. 12A, a mapping of UCI bits and UL-SCH data bits may be derived by the first UE, and a copy of the mapping may be derived by the first UE. The first UE may apply an OCC of +1 to the mapping of UCI bits and UL-SCH data bits. The first UE may apply an OCC of +1 to the copy of the mapping. In other words, for the second UE, the OCC may be [+1 +1]. As shown in FIG. 12B, a mapping of UCI bits and UL-SCH data bits may be derived by the second UE, and a copy of the mapping may be derived by the second UE. The second UE may apply an OCC of −1 to the mapping of UCI bits and UL-SCH data bits. The second UE may apply an OCC of +1 to the copy of the mapping. In other words, for the second UE, the OCC may be [+1 −1].

As indicated above, FIGS. 12A-12B are provided as examples. Other examples may differ from what is described with regard to FIGS. 10A-10B.

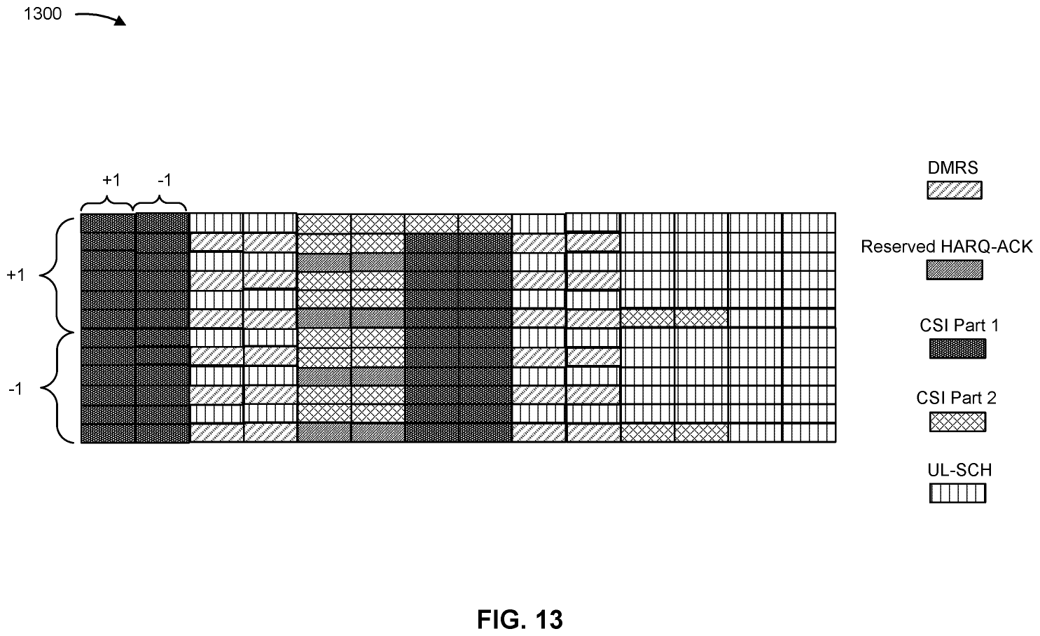

FIG. 13 is a diagram illustrating an example 1300 associated with OCC for UCI multiplexing with PUSCH, in accordance with the present disclosure.

As shown in FIG. 13, a simultaneous use of multiple OCC schemes may be supported. The OCC schemes may be used simultaneously on a PUSCH multiplexed with UCI. For example, for a particular UE, two OCCs may be used, where a first OCC may be used in an FD and a second OCC may be used at a slot level (e.g., in a TD). In this example, four UEs may be made orthogonal based at least in part on the two OCCs.

As indicated above, FIG. 13 is provided as an example. Other examples may differ from what is described with regard to FIG. 13.

In some aspects, a UE may calculate a number of REs for UCI bits, such as HARQ-ACK bits. The number of REs for HARQ-ACK bits multiplexed on a PUSCH (Q_{ACK}′) may be calculated in accordance with:

$$min \{ ⌈ \frac{( {O}_{ACK} + {L}_{ACK} ) \cdot {β}_{offset}^{PUSCH} \cdot {\sum }_{l = 0}^{{N}_{symb , all}^{PUSCH} - 1} {M}_{sc}^{UCI} ( l ) / SF}{\frac{1}{{N}_{s}} {\sum }_{r = 0}^{{C}_{UL - SCH} - 1} {K}_{r}} ⌉ , ⌈ α \cdot {\sum }_{l = {l}_{0}}^{{N}_{symb , all}^{PUSCH} - 1} {M}_{sc}^{UCI} ( l ) ⌉ \}$$

where O_{ACK} is a number of HARQ-ACK bits and Nₛ is a number of symbols. When O_{ACK}≥360, L_{ACK}=11. Otherwise, L_{ACK} is a number of cyclic redundancy check (CRC) bits for HARQ-ACK. Further, β_{offset}^{PUSCH}=β_{offset}^{HARQ-ACK}. C_{UL-SCH} is a number of code blocks for a UL-SCH of a PUSCH transmission. When a downlink control information (DCI) format scheduling a PUSCH transmission includes a code block group transmission information (CBGTI) field indicating that the UE should not transmit an r-th code block, Kᵣ=0. Otherwise, Kᵣ may be the r-th code block size for the UL-SCH of the PUSCH transmission. M_{sc}^{PUSCH} is a scheduled bandwidth of the PUSCH transmission, expressed as a number of subcarriers. M_{sc}^{PT-RS}(l) is a number of subcarriers in OFDM symbol l that carries a phase tracking reference signal (PTRS), in the PUSCH transmission. M_{sc}^{UCI}(l) is a number of REs which may be used for a transmission of UCI in OFDM symbol l, for l=0, 1, 2, . . . N_{symb,all}^{PUSCH}−1, in the PUSCH transmission (e.g., before OCC spreading), and N_{symb,all}^{PUSCH} is a total number of OFDM symbols of a PUSCH, including all OFDM symbols used for DMRS. For any OFDM symbol that carries a DMRS of the PUSCH, M_{sc}^{UCI}(l)=0. For any OFDM symbol that does not carry a DMRS of the PUSCH, M_{sc}^{UCI}(l)=M_{sc}^{PUSCH}−M_{sc}^{PT-RS}(l). Further, a is configured by a higher layer parameter scaling, and l₀ is a symbol index of a first OFDM symbol that does not carry a DMRS of the PUSCH, after first DMRS symbol(s), in the PUSCH transmission.

In some aspects, SF may be a spreading factor for the PUSCH. The SF may scale down (O_{ACK}+L_{ACK}) since Kᵣ may already capture an effect of OCC in a transport block size (TBS) calculation. When Nₛ=1, the calculated number of REs for HARQ-ACK bits multiplexed on the PUSCH may include a special case of not having TBoMS. A calculation for the number of REs for the HARQ-ACK bits multiplexed on the PUSCH may be based at least in part on the SF, where the SF may be based at least in part on a number of repetitions associated with the PUSCH.

In some aspects, a UE may calculate a number of REs for UCI bits, such as CSI part 1 bits. The number of REs for CSI part 1 bits multiplexed on a PUSCH (Q_{CSI-1}′) may be calculated in accordance with:

$$min \{ ⌈ \frac{( {O}_{CSI - 1} + {L}_{CSI - 1} ) \cdot {β}_{offset}^{PUSCH} \cdot {\sum }_{l = 0}^{{N}_{symb , all}^{PUSCH} - 1} \frac{{M}_{sc}^{UCI} ( l )}{SF}}{\frac{1}{{N}_{s}} {\sum }_{r = 0}^{{C}_{UL - SCH} - 1} {K}_{r}} ⌉ , ⌈ α \cdot {\sum }_{l = 0}^{{N}_{symb , all}^{PUSCH} - 1} {M}_{sc}^{UCI} ( l ) ⌉ - {Q}_{ACK / CG - UCI}^{′} \} ,$$

where O_{CSI-1} is a number of bits for CSI part 1, L_{CSI-1} is a number of CRC bits for the CSI part 1, and Q_{ACK/CG-UCI}′ Q_{ACK}′ when HARQ-ACK is present for a transmission on a same PUSCH with a UL-SCH and without CG-UCI, where Q_{ACK}′ is a number of coded modulation symbols per layer for HARQ-ACK transmitted on the PUSCH when a number of HARQ-ACK information bits is more than two.

In some aspects, a UE may calculate a number of REs for UCI bits, such as CSI part 2 bits. The number of REs for CSI part 2 bits multiplexed on a PUSCH (Q_{CSI-2}′) may be calculated in accordance with:

$$min \{ ⌈ \frac{( {O}_{CSI - 2} + {L}_{CSI - 2} ) \cdot {β}_{offset}^{PUSCH} \cdot {\sum }_{l = 0}^{{N}_{symb , all}^{PUSCH} - 1} {M}_{sc}^{UCI} ( l ) / SF}{{\sum }_{r = 0}^{{C}_{UL - SCH} - 1} {K}_{r}} ⌉ , ⌈ α \cdot {\sum }_{l = 0}^{{N}_{symb , all}^{PUSCH} - 1} {M}_{sc}^{UCI} ( l ) ⌉ - {Q}_{ACK / CG - UCI}^{′} - {Q}_{CSI - 1}^{′} \} ,$$

where O_{CSI-2} is a number of bits for CSI part 2, and L_{CSI-2} is a number of CRC bits for CSI part 2.

In some aspects, a UE may calculate a number of REs for UCI bits, such as CG-UCI bits. The number of REs for CG-UCI bits multiplexed on a PUSCH (Q_{CG-UCI}′) may be calculated in accordance with:

$$min \{ ⌈ \frac{( {O}_{CG - UCI} + {L}_{CG - UCI} ) \cdot {β}_{offset}^{PUSCH} \cdot {\sum }_{l = 0}^{{N}_{symb , all}^{PUSCH} - 1} {M}_{sc}^{UCI} ( l ) / SF}{\frac{1}{{N}_{s}} {\sum }_{r = 0}^{{C}_{UL - SCH} - 1} {K}_{r}} ⌉ , ⌈ \cdot {\sum }_{l = {l}_{0}}^{{N}_{symb , all}^{PUSCH} - 1} {M}_{sc}^{UCI} ( l ) ⌉ \} ,$$

where O_{CG-UCI} is a number of CG-UCI bits, and L_{CG-UCI} is a number of CRC bits for CG-UCI.

In some aspects, a UE may calculate a number of REs for HARQ-ACK bits multiplexed on a PUSCH (Q_{ACK}′) in accordance with:

$$min \{ ⌈ \frac{( {O}_{ACK} + {O}_{CG - UCI} + {L}_{ACK} ) \cdot {β}_{offset}^{PUSCH} \cdot {\sum }_{l = 0}^{{N}_{symb , all}^{PUSCH} - 1} {M}_{sc}^{UCI} ( l ) / SF}{\frac{1}{{N}_{s}} {\sum }_{r = 0}^{{C}_{UL - SCH} - 1} {K}_{r}} ⌉ , ⌈ α \cdot {\sum }_{l = {l}_{0}}^{{N}_{symb , all}^{PUSCH} - 1} {M}_{sc}^{UCI} ( l ) ⌉ \} .$$

In some aspects, a UCI multiplexing with PUSCH may ensure orthogonality. The orthogonality may be ensured by replicating a copy of a subset of REs and associated modulation symbols mapped to the REs. REs mapped to UCI bits may be replicated in a similar manner as REs mapped to UL-SCH bits. In some aspects, as an alternative, UCI bits may be multiplexed to a PUSCH that has undergone OCC (e.g., the OCC may include FD OCC, symbol-level OCC, or slot-level OCC). In other words, OCC may be initially applied to a PUSCH, and then the PUSCH may be multiplexed with the UCI bits. In this approach, a performance may degrade, but an amount of degradation may be negligible when a number of UCI bits is relatively small as compared to a number of UL-SCH bits.

In some aspects, data and control multiplexing may be implemented in accordance with pseudo code defined in Table 1. At least a portion of the pseudo code may be implemented to achieve the data and control multiplexing. In one example, with respect to Table 1, some operations defined in the pseudo code may be performed in a different order or may be skipped altogether.

```
TABLE 1
Denote the coded bits for UL-SCH as
g₀^{UL-SCH}, g₁^{UL-SCH}, g₂^{UL-SCH}, g₃^{UL-SCH}, . . . , g_{G}_{^{UL-SCH}}₋₁^{UL-SCH}.
Denote the coded bits for HARQ-ACK or jointly coded bits for HARQ-ACK and
CG-UCI when the high layer parameter cg-UCI-Multiplexing is configured, if any, as
g₀^{ACK}, g₁^{ACK}, g₂^{ACK}, g₃^{ACK}, . . . , g_{G}_{^{ACK}}₋₁^{ACK}.
Denote the coded bits for CSI part 1, if any, as
g₀^{CSI-part1}, g₁^{CSI-part1}, g₂^{CSI-part1}, g₃^{CSI-part1}, . . . , g_{G}_{^{CSI-part1}}₋₁^{CSI-part1}.
Denote the coded bits for CSI part 2, if any, as
g₀^{CSI-part2}, g₁^{CSI-part2}, g₂^{CSI-part2}, g₃^{CSI-part2}, . . . , g_{G}_{^{CSI-part2}}₋₁^{CSI-part2}.
Denote the coded bits for CG-UCI without HARQ-ACK, if any, as g₀^{CG-UCI}, g₁^{CG-UCI},
g₂^{CG-UCI}, g₃^{CG-UCI}, . . . , g_{G}_{^{CG-UCI}}₋₁^{CG-UCI}.
Denote the multiplexed data and control coded bit sequence as
g₀, g₁, g₂, g₃, . . . , g_{G-1}.
Denote l as the OFDM symbol index of the scheduled PUSCH, starting from 0 to
N_{symb,all}^{PUSCH} − 1, where N_{symb,all}^{PUSCH} is the total number of OFDM symbols of the PUSCH,
including all OFDM symbols used for DMRS. If time-domain symbol-level OCC
(T > 1) or frequency-domain OCC (F > 1) is configured and it is configured to skip
unused RE's in OFDM symbols used for DMRS, then skip such OFDM symbols.
Denote k as the subcarrier index of the scheduled PUSCH, starting from 0 to
M_{sc}^{PUSCH} − 1, where M_{sc}^{PUSCH} is expressed as a number of subcarriers. If sub-PRB
resource allocation is configured, only subcarriers (<12) scheduled for the PUSCH
are indexed.
Denote Φₗ^{UL-SCH} as the set of resource elements, in ascending order of indices k,
available for transmission of data in OFDM symbol l, for l = 0, 1, 2, . . . , N_{symb,all}^{PUSCH} −1.
Denote M_{sc}^{UL-SCH}(l) = |Φₗ^{UL-SCH}| as the number of elements in set Φₗ^{UL-SCH}. Denote
Φₗ^{UL-SCH}(j) as the j -th element in Φₗ^{UL-SCH}.
Denote Φₗ^{UCI} as the set of resource elements, in ascending order of indices k,
available for transmission of UCI in OFDM symbol l, for l = 0, 1, 2, . . . , N_{symb,all}^{PUSCH} − 1.
Denote M_{sc}^{UCI}(l) = |Φₗ^{UCI}| as the number of elements in set Φₗ^{UCI}. Denote Φₗ^{UCI}(j) as
the j -th element in Φₗ^{UCI}. For any OFDM symbol that carriers DMRS of the PUSCH,
Φₗ^{UCI} = ∅. For any OFDM symbol that does not carry DMRS of the PUSCH, Φₗ^{UCI} =
Φₗ^{UL-SCH}.
If time-domain symbol-level OCC is configured, denote T as the length of the OCC
code; otherwise, T = 1.
If frequency-domain OCC is configured, denote F as the length of the OCC code;
otherwise, F = 1.
Denote Φₗ^{UL-SCH, 0} as a subset of Φₗ^{UL-SCH} with the resource elements whose indices
k are in the range from 0 to └M_{sc}^{PUSCH}/F┘ − 1. Denote M_{sc}^{UL-SCH, 0}(l) = |Φₗ^{UL-SCH, 0}| as
the number of elements in set Φₗ^{UL-SCH, 0}. Denote Φₗ^{UL-SCH, 0}(j) as the j -th element in
Φₗ^{UL-SCH, 0}.
Denote Φₗ^{UCI, 0} as a subset of Φₗ^{UCI} with the resource elements whose indices k are in
the range from 0 to └M_{sc}^{PUSCH}/F┘ − 1. Denote M_{sc}^{UCI, 0}(l) = |Φₗ^{UCI, 0}| as the number of
elements in set Φₗ^{UCI, 0}. Denote Φₗ^{UCI, 0}(j) as the j -th element in Φₗ^{UCI, 0}.
If frequency hopping is configured for the PUSCH:
  denote l⁽¹⁾ as the OFDM symbol index of the first OFDM symbol after the first
  set of consecutive OFDM symbol(s) carrying DMRS in the first hop;
  denote l⁽²⁾ as the OFDM symbol index of the first OFDM symbol after the first
  set of consecutive OFDM symbol(s) carrying DMRS in the second hop.
  denote l_{CSI}⁽¹⁾ as the OFDM symbol index of the first OFDM symbol that does not
  carry DMRS in the first hop;
  denote l_{CSI}⁽²⁾ as the OFDM symbol index of the first OFDM symbol that does not
  carry DMRS in the second hop;
  if HARQ-ACK is present for transmission on the PUSCH with UL-SCH or if
  both HARQ-ACK and CG-UCI are present on the same PUSCH with UL-SCH, let
    G^{ACK}(1) = N_{L} · Qₘ · └G^{ACK}/(2 · N_{L} · Qₘ)┘ and G^{ACK}(2) = N_{L} · Qₘ ·
    ┌G^{ACK}/(2 · N_{L} · Qₘ)]┐ ;
  if CSI is present for transmission on the PUSCH with UL-SCH, let
    G^{CSI-part1}(1) = N_{L} · Qₘ · └G^{CSI-part1}/(2 · N_{L} · Qₘ)┘;
    G^{CSI-part1}(2) = N_{L} · Qₘ · └G^{CSI-part1}/(2 · N_{L} · Qₘ)┘ ;
    G^{CSI-part2}(1) = N_{L} · Qₘ · └G^{CSI-part2}/(2 · N_{L} · Qₘ)┘; and
    G^{CSI-part2}(2) = N_{L} · Qₘ · └G^{CSI-part2}/(2 · N_{L} · Qₘ)┘ ;
  if CG-UCI is present for transmission on the PUSCH with UL-SCH and
  without HARQ-ACK, let
    G^{CG-UCI}(1) = N_{L} · Qₘ · └G^{CG-UCI}/(2 · N_{L} · Qₘ)┘ and G^{CG-UCI}(2) = N_{L} ·
    Qₘ · └G^{CG-UCI}/(2 · N_{L} · Qₘ)┘
  if only HARQ-ACK and CSI part 1 are present for transmission on the PUSCH
  without UL-SCH, let
    G^{ACK}(1) = min(N_{L} · Qₘ · └G_{ACK}/(2 · N_{L} · Qₘ)┘, M₃ · N_{L} · Qₘ);
    G^{ACK}(2) = G^{ACK} − G^{ACK}(1) ;
    G^{CSI-part1}(1) = M₁ · N_{L} · Qₘ − G^{ACK}(1); and
    G^{CSI-part1}(2) = G^{CSI-part1} − G^{CSI-part1}(1) ;
  if HARQ-ACK, CSI part 1 and CSI part 2 are present for transmission on the
  PUSCH without UL-SCH, let
    G^{ACK}(1) = min(N_{L} · Qₘ · └G^{ACK}/(2 · N_{L} · Qₘ)┘, M₃ · N_{L} · Qₘ);
    G^{ACK}(2) = G^{ACK} − G^{ACK}(1) ;
    if the number of HARQ-ACK information bits is more than 2,G^{CSI-part1}(1) =
    min(N_{L} · Qₘ · └G^{CSI-part1}/(2 · N_{L} · Qₘ)┘, M₁ · N_{L} · Qₘ − G^{ACK}(1));
    otherwise, G^{CSI-partl}(1) = min(N_{L} · Qₘ · └G^{CSI-part1}/(2 · N_{L} · Qₘ)┘, M₁ ·
    N_{L} · Qₘ − G_{rvd}^{ACK}(1))
    G^{CSI-part1}(2) = G^{CSI-part1} − G^{CSI-part1}(1) ;
    G^{CSI-part2}(1) = M₁ · N_{L} · Qₘ − G^{CSI-part1}(1) if the number of HARQ-ACK
    information bits is no more than 2, and G^{CSI-part2}(1) = M₁ · N_{L} · Qₘ − G^{ACK}(1) − G^{CSI-part1}(1)
    otherwise; and
    G^{CSI-part2}(2) = M₂ · N_{L} · Qₘ − G^{CSI-part1}(2) if the number of HARQ-ACK
    information bits is no more than 2, and G^{CSI-part2}(2) = M₂ · N_{L} · Qₘ −
    G^{ACK}(2) − G^{CSI-part1}(2) otherwise;
  if only CSI part 1 and CSI part 2 are present for transmission on the PUSCH
  without UL-SCH, let
    G^{CSI-part1}(1) = min(N_{L} · Qₘ · └G^{CSI-part1}/(2 · N_{L} · Qₘ)┘ , M₁ · N_{L} · Qₘ −
    G_{rvd}^{ACK}(1));
    G^{CSI-part1}(2) = G^{CSI-part1} − G^{CSI-part1}(1) ;
    G^{CSI-part2}(1) = M₁ · N_{L} · Qₘ − G^{CSI-part1}(1); and
    G^{CSI-part2}(2) = M₂ · N_{L} · Qₘ − G^{CSI-part1}(2);
  let Nₕₒₚ^{PUSCH} = 2, and denote N_{symb,hop}^{PUSCH}(1), N_{symb,hop}^{PUSCH}(2) as the number of OFDM
  symbols of the PUSCH in the first and second hop, respectively;
  N_{L} is the number of transmission layers of the PUSCH;
  Qₘ is the modulation order of the PUSCH;
  ${M}_{1} = {\sum }_{l = 0}^{{N}_{symb , hop}^{PUSCH} ( 1 ) - 1} {M}_{S C}^{UCI , 0} ( l ) ;$
  ${M}_{2} = {\sum }_{l = {N}_{symb , hop}^{P U S C H} ( 1 )}^{{N}_{symb , hop}^{PUSCH} ( 1 ) + {N}_{symb , hop}^{PUSCH} ( 2 ) - 1} {M}_{S C}^{UCI , 0} ( l )$
  ${M}_{3} = {\sum }_{l = {l}^{( 1 )}}^{{N}_{symb , hop}^{PUSCH} ( 1 ) - 1} {M}_{S C}^{UCI , 0} ( l ) .$
If frequency hopping is not configured for the PUSCH,
  denote l⁽¹⁾ as the OFDM symbol index of the first OFDM symbol after the first
  set of consecutive OFDM symbol(s) carrying DMRS;
  denote l_{CSI}⁽¹⁾ as the OFDM symbol index of the first OFDM symbol that does not
  carry DMRS;
  if HARQ-ACK is present for transmission on the PUSCH or if both HARQ-
  ACK and CG-UCI are present on the same PUSCH with UL-SCH, let
  G^{ACK}(1) = G^{ACK};
  if CSI is present for transmission on the PUSCH, let G^{CSI-part1}(1) = G^{CSI-part1}
  and G^{CSI-part2}(1) = G^{CSI-part2};
  if CG-UCI is present for transmission on the PUSCH without HARQ-ACK, let
  G^{CG-UCI}(1) = G^{CG-UCI};
  let Nₕₒₚ^{PUSCH} = 1 and N_{symb,hop}^{PUSCH}(1) = N_{symb,all}^{PUSCH}.
The multiplexed data and control coded bit sequence g₀, g₁, g₂, g₃, . . . , g_{G-1} may be
obtained according to the following:
```

First Operation:

```
  Set Φ̅ₗ^{UL-SCH, 0} = Φₗ^{UL-SCH, 0} for l = 0, 1, 2, . . . , N_{symb,all}^{PUSCH} − 1;
  Set M̅_{sc}^{UL-SCH, 0}(l) = |Φ̅ₗ^{UL-SCH, 0}| for l = 0, 1, 2, . . . , N_{symb,all}^{PUSCH} − 1;
  Set Φ̅ₗ^{UCI, 0} = Φₗ^{UL-SCH, 0} for l = 0, 1, 2, . . . , N_{symb,all}^{PUSCH} − 1;
  Set M̅_{sc}^{UCI, 0}(l) = |Φ̅ₗ^{UCI, 0}| for l = 0, 1, 2, . . . , N_{symb,all}^{PUSCH} − 1;
if the number of HARQ-ACK information bits to be transmitted on PUSCH is 0, 1 or
2 bits and without CG-UCI
  the number of reserved resource elements for potential HARQ-ACK transmission
    is calculated, by setting O_{ACK} = 2;
  denote G_{rvd}^{ACK} as the number of coded bits for potential HARQ-ACK transmission
    using the reserved resource elements;
  if frequency hopping is configured for the PUSCH, let G_{rvd}^{ACK}(1) = N_{L} · Qₘ ·
    └G_{rvd}^{ACK}/(2 · N_{L} · Qₘ)┘ and G_{rvd}^{ACK}(2) = N_{L} · Qₘ · ┌G_{rvd}^{ACK}/(2 · N_{L} · Qₘ)┐ ;
  if frequency hopping is not configured for the PUSCH, let G_{rvd}^{ACK}(1) = G_{rvd}^{ACK};
  denote Φ̅ₗ^{rvd} as the set of reserved resource elements for potential HARQ-ACK
    transmission, in OFDM symbol l, for 1 = 0, 1, 2, . . . , N_{symb,all}^{PUSCH} − 1;
  denote Φ̅ₗ^{rvd, 0} as a subset of Φ̅ₗ^{rvd} with the resource elements whose indices k are in
    the range from 0 to └M_{sc}^{PUSCH}/F┘ − 1, in OFDM symbol l, for l =
    0, 1, 2, . . . , N_{symb,all}^{PUSCH} − 1;
  Set m_{count}^{ACK}(1) = 0;
  Set m_{count}^{ACK}(2) = 0;
  Φ̅ₗ^{rvd, 0} = ∅ for l = 0, 1, 2, . . . , N_{symb,all}^{PUSCH} − 1;
  for i = 1 to Nₕₒₚ^{PUSCH}
    l = l⁽ⁱ⁾;
    while m_{count}^{ACK}(i) < G_{rvd}^{ACK}(i)
      if M̅_{sc}^{UCI}(l) > 0
        if G_{rvd}^{ACK}(i) − m_{count}^{ACK}(i) ≥ M̅_{sc}^{UCI, 0}(l) · N_{L} · Qₘ
          d = 1;
            m_{count}^{RE} = M̅_{sc}^{UL-SCH,0}(l)
        end if
        if G_{rvd}^{ACK}(i) − m_{count}^{ACK}(i) < M̅_{sc}^{UCI, 0}(l) · N_{L} · Qₘ
          $d = ⌊ \frac{{\overline{M}}_{s c}^{UCI , 0} ( l ) \cdot {N}_{L} \cdot {Q}_{m}}{( {G}_{rvd}^{ACK} ( i ) - {m}_{count}^{ACK} ( i ) )} ⌋ ;$
          m_{count}^{RE} = ┌(G_{rvd}^{ACK}(i) − m_{count}^{ACK}(i))/(N_{L} · Qₘ)┐ ;
        end if
        for j = 0 to m_{count}^{RE} − 1
          Φ̅ₗ^{rvd, 0} = Φ̅ₗ^{rvd, 0} ∪ {Φ̅ₗ^{UL-SCH, 0}(j · d)}
            m_{count}^{ACK}(i) = m_{count}^{ACK}(i) + N_{L} · Qₘ;
          end for
        end if
      l = l + T;
      end while
    end for
else
  Φ̅ₗ^{rvd,0} = ∅ for l = 0, 1, 2, . . . , N_{symb,all}^{PUSCH} − 1;
end if
Denote M̅_{sc, rvd, 0}^{Φ̅}(l) = |Φ̅ₗ^{rvd, 0}| as the number of elements in Φ̅ₗ^{rvd, 0}.
```

Second Operation:

```
If HARQ-ACK is present for transmission on the PUSCH and the number of HARQ-
ACK information bits is more than 2 or if both HARQ-ACK and CG-UCI are present
on the same PUSCH with UL-SCH,
  Set m_{count}^{ACK}(1) = 0;
  Set m_{count}^{ACK}(2) = 0;
  Set m_{count,all}^{ACK}(3) = 0;
  for i = 1 to Nₕₒₚ^{PUSCH}
    l = l⁽ⁱ⁾ ;
    while m_{count}^{ACK}(i) < G^{ACK}(i)
      if M̅_{sc}^{UCI}(l) > 0
        if G^{ACK}(i) − m_{count}^{ACK}(i) ≥ M̅_{sc}^{UCI, 0}(l) · N_{L} · Qₘ
          d = 1;
          m_{count}^{RE} = M̅_{sc}^{UCI, 0}(l);
        end if
        if G^{ACK}(i) − m_{count}^{ACK}(i) < M̅_{sc}^{UCI, 0}(l) · N_{L} · Qₘ
          $d = ⌊ \frac{{\overline{M}}_{s c}^{UCI , 0} ( l ) \cdot {N}_{L} \cdot {Q}_{m}}{( {G}^{ACK} ( i ) - {m}_{count}^{ACK} ( i ) )} ⌋ ;$
          m_{count}^{RE} = ┌(G^{ACK}(i) − m_{count}^{ACK}(i))/(N_{L} · Qₘ)┐ ;
        end if
        for j = 0 to m_{count}^{RE} − 1
          k = Φ̅ₗ^{UCI, 0}(j · d)
          for v = 0 to N_{L} · Qₘ − 1
            g̅_{l,k,v} = gₘ_{_{count, all}}_{^{ACK}}^{ACK};
            m_{count,all}^{ACK} = m_{count,all}^{ACK} + 1;
            m_{count}^{ACK}(i) = m_{count}^{ACK}(i) + 1;
          end for
        end for
        Φ̅_{l,tmp}^{UCI} = ∅;
        for j = 0 to m_{count}^{RE} − 1
          Φ̅_{l,tmp}^{UCI} = Φ̅_{l,tmp}^{UCI} = ∪ Φ̅ₗ^{UCI, 0}(j · d);
        end for
        Φ̅ₗ^{UCI,0} = Φ̅ₗ^{UCI,0}\Φ̅_{l,tmp}^{UCI};
        Φ̅ₗ^{UL-SCH,0} = Φ̅ₗ^{UL-SCH,0}\Φ̅_{l,tmp}^{UCI};
        M̅_{sc}^{UCI,0}(l) = |Φ̅ₗ^{UCI,0}|;
        M̅_{sc}^{UL-SCH,0}(l) = |Φ̅ₗ^{UL-SCH,0}|;
      end if
      l = l + T;
    end while
  end for
end if
if CG-UCI is present for transmission on the PUSCH without HARQ-ACK,
  Set m_{count}^{CG-UCI}(1) = 0;
  Set m_{count}^{CG-UCI}(2) = 0;
  Set m_{count,all}^{CG-UCI} = 0;
  for i = 1 to Nₕₒₚ^{PUSCH}
    l = l⁽ⁱ⁾;
    while m_{count}^{CG-UCI}(i) < G^{CG-UCI}(i)
    if M̅_{sc}^{UCI}(l) > 0
      if G^{CG-UCI}(i) − m_{count}^{CG-UCI}(1) ≥ M̅_{sc}^{UCI,0}(l) · N_{L} · Qₘ
        d = 1;
        m_{count}^{RE} = M̅_{sc}^{UCI,0}(l);
      end if
      if G^{CG-UCI}(i) − m_{count}^{CG-UCI}(1) < M̅_{sc}^{UCI,0}(l) · N_{L} · Qₘ
        d = └M̅_{sc}^{UCI,0}(l) · N_{L} · Qₘ /(G^{CG-UCI}(i) − m_{count}^{CG -UCI}(i))┘;
        m_{count}^{RE} = ┌(G^{CG-UCI}(i) − m_{count}^{CG-UCI}(i))/(N_{L} · Qₘ)];
      end if
      for j = 0 to m_{count}^{RE} − 1
        k = Φ̅ₗ^{UCI,0}(j · d);
        for v = 0 to N_{L} · Qₘ − 1
          g̅_{l,k,v} = gₘ_{_{count,all}}_{^{CG-UCI}}^{CG-UCI};
          m_{count,all}^{CG-UCI} = m_{count,all}^{CG-UCI} + 1;
          m_{count}^{CG-UCI}(i) = m_{count}^{CG-UCI}(i) + 1;
        end for
      end for
      Φ̅_{l,tmp}^{UCI} = ∅;
      for j = 0 to m_{count}^{RE} − 1
        Φ̅_{l,tmp}^{UCI} = Φ̅_{l,tmp}^{UCI} ∪ Φ̅ₗ^{UCI,0}(j · d);
      end for
        Φ̅ₗ^{UCI,0} = Φ̅ₗ^{UCI,0}\Φ̅_{l,tmp}^{UCI};
        Φ̅ₗ^{UL-SCH,0} = Φ̅ₗ^{UL-SCH,0}\Φ̅_{l,tmp}^{UCI};
        M̅_{sc}^{UCI,0}(l) = |Φ̅ₗ^{UCI,0}|;
        M̅_{sc}^{UL-SCH,0}(l) = |Φ̅ₗ^{UL-SCH,0}|;
      end if
      l = l + T;
    end while
  end for
end if
```

Third Operation:

```
If CSI is present for transmission on the PUSCH,
  Set m_{count}^{CSI-part1}(1) = 0;
  Set m_{count}^{CSI-part1}(2) = 0;
  Set m_{count}^{CSI-part1} = 0;
  for i = 1 to Nₕₒₚ^{PUSCH}
    l = l_{CSI}⁽ⁱ⁾;
    while M̅_{sc}^{UCI, 0}(l) − M̅_{sc, rvd, 0}^{Φ̅}(l) ≤ 0
      l = l + 1;
    end while
    while m_{count}^{CSI-part1}(i) < G^{CSI-part1}(i)
      if M̅_{sc}^{UCI, 0}(l) − M̅_{sc, rvd, 0}^{Φ̅}(l) > 0
        if G^{CSI-part1}(i) − m_{count}^{CSI-part1}(i) ≥ (M̅_{sc}^{UCI, 0}(l) − M̅_{sc, rvd, 0}^{Φ̅}(l)) · N_{L} · Qₘ
          d = 1;
          m_{count}^{RE} = M̅_{sc}^{UCI, 0}(l) − M̅_{sc, rvd, 0}^{Φ̅}(l);
        end if
        if G^{CSI-part1}(i) − m_{count}^{CSI-part1}(i) < (M̅_{sc}^{UCI, 0}(l) − M̅_{sc, rvd, 0}^{Φ̅}(l)) · N_{L} · Qₘ
          $d = ⌊ \frac{( {\overline{M}}_{sc}^{UCI , 0} ( l ) - {M}_{sc , rvd , 0}^{\overline{Φ}} ( l ) ) \cdot {N}_{L} \cdot {Q}_{m}}{( {G}^{CSI - part 1} ( i ) - {m}_{count}^{CSI - part 1} ( i ) )} ⌋ ;$
            m_{count}^{RE} = ┌(G^{CSI-part1}(i) − m_{count}^{CSI-part1}(i))/(N_{L} · Qₘ)] ;
          end if
          Φ̅ₗ^{temp} = Φ̅ₗ^{NCI, 0}\Φ̅ₗ^{rvd, 0};
          for j = 0 to m_{count}^{RE} − 1
            k = Φ̅ₗ^{temp}(j · d);
            for v = 0 to N_{L} · Qₘ − 1
              g̅_{l,k,v} = gₘ_{_{count,all}}_{^{CSI-part1}}^{CSI-part1};
          m_{count,all}^{CSI-part1} = m_{count,all}^{CSI-part1} + 1;
          m_{count}^{CSI-part1}(i) = m_{count}^{CSI-part1}(i) + 1;
        end for
      end for
      Φ̅_{l,temp}^{UCI} = ∅;
        for j = 0 to m_{count}^{RE} − 1
          Φ̅_{l,tmp}^{UCI} = Φ̅_{l,tmp}^{UCI} ∪ Φ̅ₗ^{temp}(j · d);
        end for
        Φ̅ₗ^{UCI, 0} = Φ̅ₗ^{UCI, 0}\Φ̅_{l,tmp}^{UCI};
        Φ̅ₗ^{UL-SCH, 0} = Φ̅ₗ^{UL-SCH, 0}\Φ̅_{l,tmp}^{UCI};
        M̅_{sc}^{UCI, 0}(l) = |Φ̅ₗ^{UCI, 0}|;
        M̅_{sc}^{UL-SCH, 0}(l) = |Φ̅ₗ^{UL-SCH, 0}|;
      end if
      l = l + T;
    end while
  end for
end if
  Set m_{count}^{CSI-part2}(1) = 0;
  Set m_{count}^{CSI-part2}(2) = 0;
  Set m_{count,all}^{CSI-part2} = 0;
  for i = 1 to Nₕₒₚ^{PUSCH}
    l = l_{CSI}⁽ⁱ⁾;
    while M̅_{sc}^{UCI, 0}(l) ≤ 0
      l = l + 1;
    end while
    while m_{count}^{CSI-part2}(i) < G^{CSI-part2}(i)
      if M̅_{sc}^{UCI, 0}(l) > 0
        if G^{CSI-part2}(i) − m_{count}^{CSI-part2}(i) ≥ M̅_{sc}^{UCI, 0}(l) · N_{L} · Qₘ
        d = 1;
          m_{count}^{RE} = M̅_{sc}^{UCI, 0}(l);
        end if
        if G^{CSI-part2}(i) − m_{count}^{CSI-part2}(i) < M̅_{sc}^{UCI, 0}(l) · N_{L} · Qₘ
          $d = ⌊ \frac{{\overline{M}}_{sc}^{UCI , 0} ( l ) \cdot {N}_{L} \cdot {Q}_{m}}{( {G}^{CSI - part 2} ( i ) - {m}_{count}^{CSI - part 2} ( i ) )} ⌋ ;$
          m_{count}^{RE} = ┌(G^{CSI-part2}(i) − m_{count}^{CSI-part2}(i))/(N_{L} · Qₘ)┐ ;
        end if
        for j = 0 to m_{count}^{RE} − 1
          k = Φ̅ₗ^{UCI, 0}(j · d)
          for v = 0 to N_{L} · Qₘ − 1
            g̅_{l,k,v} = gₘ_{_{count, all}}_{^{CSI-part2}}^{CSI-part2};
            m_{count,all}^{CSI-part2} = m_{count,all}^{CSI-part2} + 1;
            m_{count}^{CSI-part2}(i) = m_{count}^{CSI-part2}(i) + 1;
          end for
        end for
        Φ̅_{l,tmp}^{UCI} = ∅;
        for j = 0 to m_{count}^{RE} − 1
          Φ̅_{l,tmp}^{UCI} = Φ̅_{l,tmp}^{UCI} = ∪ Φ̅ₗ^{UCI, 0}(j · d);
        end for
        Φ̅ₗ^{UCI, 0} = Φ̅ₗ^{UCI, 0}\Φ̅_{l,tmp}^{UCI};
        Φ̅ₗ^{UL-SCH, 0} = Φ̅ₗ^{UL-SCH, 0}\Φ̅_{l,tmp}^{UCI};
        M̅_{sc}^{UCI, 0}(l) = |Φ̅ₗ^{UCI, 0}|;
        M̅_{sc}^{UL-SCH, 0}(l) = |Φ̅ₗ^{UL-SCH, 0}|;
      end if
      l = l + T;
    end while
  end for
end if
```

Forth Operation:

```
If CG-UCI is present for transmission on the PUSCH,
  Set m_{count}^{UL-SCH} = 0;
  for p = 0 to └N_{symb,all}^{PUSCH}/T┘ − 1
    l = p · T
    if M̅_{sc}^{UL-SCH, 0}(l) > 0
      for j = 0 to M̅_{sc}^{UL-SCH, 0}(l) − 1
        k = Φ̅ₗ^{UL-SCH, 0} (j);
        for v = 0 to N_{L} · Qₘ − 1
          g̅_{l,k,v} = gₘ_{_{count}}_{^{UL-SCH}}^{UL-SCH};
          m_{count}^{UL-SCH} = m_{count}^{UL-SCH} + 1;
        end for
      end for
    end if
  end for
end if
```

Fifth Operation:

```
If HARQ-ACK is present for transmission on the PUSCH without CG-UCI and the
number of HARQ-ACK information bits is no more than 2,
  Set m_{count}^{ACK}(1) = 0;
  Set m_{count}^{ACK}(2) = 0;
  Set m_{count,all}^{ACK} = 0;
  for i = 1 to Nₕₒₚ^{PUSCH}
    l = l⁽ⁱ⁾ ;
    while m_{count}^{ACK}(i) < G^{ACK}(i)
      if M̅_{sc, rvd, 0}^{Φ̅}(l) > 0
        if G^{ACK}(i) − m_{count}^{ACK}(i) ≥ M̅_{sc, rvd, 0}^{Φ̅}(l) · N_{L} · Qₘ
          d = 1;
          m_{count}^{RE} = M̅_{sc, rvd, 0}^{Φ̅}(l);
        end if
        if G^{ACK}(i) − m_{count}^{ACK}(i) < M̅_{sc, rvd, 0}^{Φ̅}(l) · N_{L} · Qₘ
          $d = ⌊ \frac{{\overline{M}}_{sc , rvd , 0}^{\overline{Φ}} ( l ) \cdot {N}_{L} \cdot {Q}_{m}}{( {G}^{ACK} ( i ) - {m}_{count}^{ACK} ( i ) )} ⌋ ;$
          m_{count}^{RE} =┌(G^{ACK}(i) − m_{count}^{ACK}(i))/(N_{L} · Qₘ)┐ ;
        end if
        for j = 0 to m_{count}^{RE} − 1
          k = Φ̅ₗ^{rvd, 0}(j · d);
          for v = 0 to N_{L} · Qₘ − 1
            g̅_{l,k,v} = gₘ_{_{count, all}}_{^{ACK}}^{ACK};
            m_{count,all}^{ACK} = m_{count,all}^{ACK} + 1;
            m_{count}^{ACK}(i) = m_{count}^{ACK}(i) + 1;
          end for
        end for
      end if
      l = l + T;
    end while
  end for
end if
```

Sixth Operation:

```
Set t = 0;
for p = 0 to └N_{symb,all}^{PUSCH}/T┘ − 1
  l = p · T
  for j = 0 to M_{sc}^{UL-SCH, 0}(l) − 1
    k = Φₗ^{UL-SCH, 0}(j);
    for v = 0 to N_{L} · Qₘ − 1
      gₜ = g̅_{l,k,v};
      t = t + 1;
    end for
  end for
end for
```

| | |
|---|---|
| Seventh Operation: | (Apply OCC) |

```
If F > 1,
      repeat the mapping of UCI bits and the UL-SCH bits in steps 1-6 in each of
the F − 1 sets of subcarriers Φ̅ₗ^{UL-SCH,f} defined as a subset of Φ̅ₗ^{UL-SCH,f} with
subcarriers indexed by k = w · F + f, where w = 0 to └M_{sc}^{PUSCH/F}┘ − 1, and f =
1, 2, . . . , F − 1,
      scramble the multiplexed UCI bits and the UL-SCH bits the same way
    across the F subsets
      modulate the scrambled UCI bits and the UL-SCH bits with the same
      modulation order in the F subsets
      multiply the OCC code across the F subsets of subcarriers Φ̅ₗ^{UL-SCH,f}, f =
0, 2, . . . , F − 1.
If T > 1,
      repeat the mapping of UCI bits and the UL-SCH bits in steps 1-6 in symbols l =
p · T + q, where p = 0 to └N_{symb,all}^{PUSCH}/T┘ − 1, and q = 1, 2, . . . , T − 1,
      scramble the multiplexed UCI bits and the UL-SCH bits the same way
    across the T subsets
      modulate the scrambled UCI bits and the UL-SCH bits with the same
    modulation order in the T subsets
      multiply the OCC code across the T subsets of symbols, where the qth
subset consists of symbols with indices l = p · T + q, where p = 0 to └N_{symb,all}^{PUSCH}/T┘ −
1, and q = 0, 2, . . . , T − 1.
If time-domain slot-level OCC of OCC codelength V is configured, do the mapping
of UCI bits and UL-SCH bits in steps 1-6 in the first slot allocated to the PUSCH, and
then repeat the mapping for the next V − 1 slots, and finally multiply the OCC code
with the modulated symbols in the resource elements across the V slots.
```

In some aspects, with respect to Table 1, only a subset of the operations may be performed, and/or a different ordering of the operations may be used.

FIG. 14 is a diagram illustrating an example process 1400 performed, for example, at a UE or an apparatus of a UE, in accordance with the present disclosure. Example process 1400 is an example where the apparatus or the UE (e.g., UE 120) performs operations associated with OCCs for UCI multiplexing with PUSCHs.

As shown in FIG. 14, in some aspects, process 1400 may include mapping UCI bits and UL-SCH data bits to a first subset of resources associated with a PUSCH (block 1410). For example, the UE (e.g., using communication manager 140 and/or mapping component 1508, depicted in FIG. 15) may map UCI bits and UL-SCH data bits to a first subset of resources associated with a PUSCH, as described above.

As further shown in FIG. 14, in some aspects, process 1400 may include copying symbols associated with the UCI bits and the UL-SCH data bits from the first subset of resources to one or more remaining subsets of resources associated with the PUSCH, to obtain copied symbols associated with the UCI bits and the UL-SCH data bits, based at least in part on a repetition pattern (block 1420). For example, the UE (e.g., using communication manager 140 and/or copying component 1510, depicted in FIG. 15) may copy symbols associated with the UCI bits and the UL-SCH data bits from the first subset of resources to one or more remaining subsets of resources associated with the PUSCH, to obtain copied symbols associated with the UCI bits and the UL-SCH data bits, based at least in part on a repetition pattern, based at least in part on a repetition pattern, as described above.

As further shown in FIG. 14, in some aspects, process 1400 may include applying an OCC across a plurality of subsets of resources, including the first subset of resources and the one or more remaining subsets of resources, associated with the PUSCH based at least in part on the repetition pattern (block 1430). For example, the UE (e.g., using communication manager 140 and/or applying component 1512, depicted in FIG. 15) may apply an OCC across a plurality of subsets of resources, including the first subset of resources and the one or more remaining subsets of resources, associated with the PUSCH based at least in part on the repetition pattern, as described above.

As further shown in FIG. 14, in some aspects, process 1400 may include transmitting, based at least in part on the OCC applied across the plurality of subsets of resources, multiplexed UCI bits and UL-SCH data bits, the multiplexed UCI bits and UL-SCH data bits being based at least in part on the symbols associated with the UCI bits and the UL-SCH bits associated with the first subset of resources and the copied symbols associated with the UCI bits and the UL-SCH data bits associated with the one or more remaining subsets of resources (block 1440). For example, the UE (e.g., using communication manager 140 and/or transmission component 1504, depicted in FIG. 15) may transmit, based at least in part on the OCC applied across the plurality of subsets of resources, multiplexed UCI bits and UL-SCH data bits, the multiplexed UCI bits and UL-SCH data bits being based at least in part on the symbols associated with the UCI bits and the UL-SCH bits associated with the first subset of resources and the copied symbols associated with the UCI bits and the UL-SCH data bits associated with the one or more remaining subsets of resources, as described above.

Process 1400 may include additional aspects, such as any single aspect or any combination of aspects described below and/or in connection with one or more other processes described elsewhere herein.

In a first aspect, subcarriers allocated to the PUSCH are partitioned into the plurality of subsets of resources, and the first subset of resources is associated with a plurality of contiguous subcarriers or a plurality of non-contiguous subcarriers.

In a second aspect, alone or in combination with the first aspect, DMRS symbols are excluded from the OCC, and UCI bits or UL-SCH data bits are excluded from being mapped to one or more unused REs of a symbol occupied by DMRS.

In a third aspect, alone or in combination with one or more of the first and second aspects, DMRS symbols are included for the OCC, and UL-SCH data bits are mapped to one or more unused REs of a symbol occupied by DMRS.

In a fourth aspect, alone or in combination with one or more of the first through third aspects, the OCC is a frequency domain OCC applied by multiplying an OCC codeword across the plurality of subsets of resources.

In a fifth aspect, alone or in combination with one or more of the first through fourth aspects, symbols allocated to the PUSCH are partitioned into the plurality of subsets of resources, and the first subset of resources is associated with a plurality of contiguous symbols or a plurality of non-contiguous symbols.

In a sixth aspect, alone or in combination with one or more of the first through fifth aspects, DMRS symbols are excluded from the OCC, and the UCI bits or the UL-SCH data bits are excluded from being mapped to the plurality of subsets of resources.

In a seventh aspect, alone or in combination with one or more of the first through sixth aspects, DMRS symbols are included for the OCC, and at least one of the DMRS symbols is excluded from the first subset of resources.

In an eighth aspect, alone or in combination with one or more of the first through seventh aspects, one or more DMRS REs in a symbol of a comb that is nearest to a DMRS symbol, in relation to other DMRS REs, are marked as unavailable.

In a ninth aspect, alone or in combination with one or more of the first through eighth aspects, information associated with a DMRS RE is copied to a symbol in a comb that is nearest to a DMRS symbol, in relation to other DMRS symbols.

In a tenth aspect, alone or in combination with one or more of the first through ninth aspects, the OCC is a symbol-level OCC applied by multiplying, in a time domain, an OCC codeword across the plurality of subsets of resources.

In an eleventh aspect, alone or in combination with one or more of the first through tenth aspects, one or more unused REs on DMRS symbols are used for the UL-SCH data bits with the OCC, and the DMRS symbols fall into the first subset of resources.

In a twelfth aspect, alone or in combination with one or more of the first through eleventh aspects, one or more unused REs on DMRS symbols are used for the UL-SCH data bits with the OCC, and a portion of DMRS symbols fall outside of the first subset of resources.

In a thirteenth aspect, alone or in combination with one or more of the first through twelfth aspects, slots allocated to the PUSCH are partitioned into the plurality of subsets of resources, and the first subset of resources is associated with a plurality of contiguous slots or a plurality of non-contiguous slots.

In a fourteenth aspect, alone or in combination with one or more of the first through thirteenth aspects, the OCC is a slot-level OCC applied by multiplying, in a time domain, an OCC codeword across the plurality of subsets of resources.

In a fifteenth aspect, alone or in combination with one or more of the first through fourteenth aspects, the OCC is associated with multiple OCC schemes simultaneously applied in a frequency domain and in a time domain.

In a sixteenth aspect, alone or in combination with one or more of the first through fifteenth aspects, a number of REs for the multiplexed UCI bits and UL-SCH data bits is based at least in part on a spreading factor for the PUSCH, and the spreading factor is based at least in part on the repetition pattern.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication, in accordance with the present disclosure. The apparatus 1500 may be a UE, or a UE may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include the communication manager 140. The communication manager 140 may include one or more of a mapping component 1508, a copying component 1510, or an applying component 1512, among other examples.

In some aspects, the apparatus 1500 may be configured to perform one or more operations described herein in connection with FIGS. 6, 7A-7F, 8A-8B, 9A-9G, 10A-10B, 11A-11C, 12A-12B, and/or 13. Additionally, or alternatively, the apparatus 1500 may be configured to perform one or more processes described herein, such as process 1400 of FIG. 14. In some aspects, the apparatus 1500 and/or one or more components shown in FIG. 15 may include one or more components of the UE described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1504 may be co-located with the reception component 1502 in one or more transceivers.

The mapping component 1508 may map UCI bits and UL-SCH data bits to a first subset of resources associated with a PUSCH. The copying component 1510 may copy symbols associated with the UCI bits and the UL-SCH data bits from the first subset of resources to one or more remaining subsets of resources associated with the PUSCH, to obtain copied symbols associated with the UCI bits and the UL-SCH data bits, based at least in part on a repetition pattern. The applying component 1512 may apply an OCC across a plurality of subsets of resources, including the first subset of resources and the one or more remaining subsets of resources, associated with the PUSCH based at least in part on the repetition pattern. The transmission component 1504 may transmit, based at least in part on the OCC applied across the plurality of subsets of resources, multiplexed UCI bits and UL-SCH data bits, the multiplexed UCI bits and UL-SCH data bits being based at least in part on the symbols associated with the UCI bits and the UL-SCH bits associated with the first subset of resources and the copied symbols associated with the UCI bits and the UL-SCH data bits associated with the one or more remaining subsets of resources.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

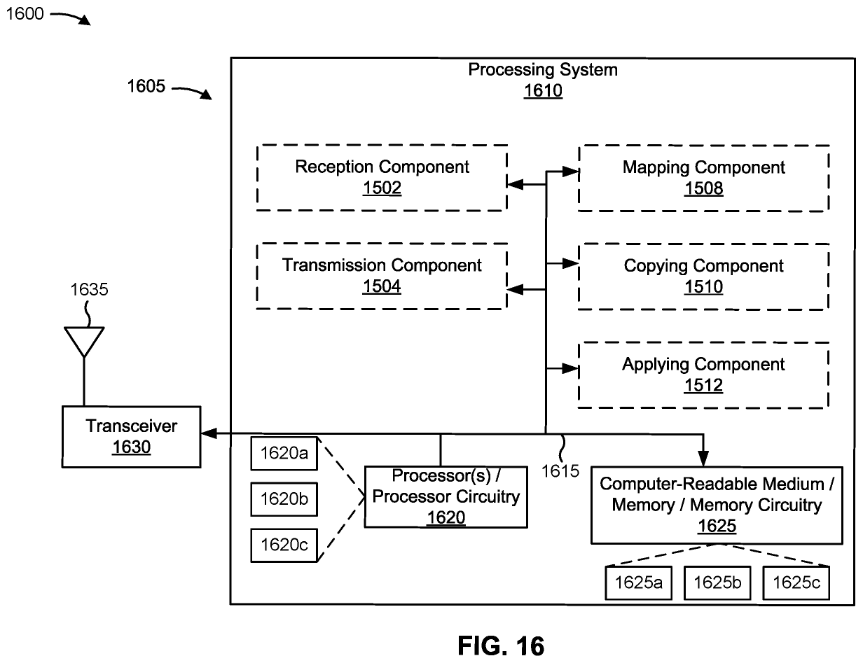

FIG. 16 is a diagram illustrating an example 1600 of a hardware implementation for an apparatus 1605 employing a processing system 1610, in accordance with the present disclosure. The apparatus 1605 may be a UE or may be at (e.g., included in) a UE.

The processing system 1610 may be implemented with a bus architecture, represented generally by the bus 1615. The bus 1615 may include any number of interconnecting buses and bridges depending on the specific application of the processing system 1610 and the overall design constraints. The bus 1615 links together various circuits including one or more processors and/or hardware components, represented by the processor (or processing circuitry) 1620, the illustrated components, and the computer-readable medium/memory (or memory circuitry) 1625. The processor 1620 may include multiple processors, such as processor 1620a, memory 1620b, and memory 1620c. The memory 1625 may include multiple memories, such as memory 1625a, memory 1625b, and memory 1625c. The bus 1615 may also link various other circuits, such as timing sources, peripherals, voltage regulators, and/or power management circuits.

The processing system 1610 may be coupled to one or more transceivers 1630. A transceiver 1630 is coupled to one or more antennas 1635. The transceiver 1630 provides a means for communicating with various other apparatuses over a transmission medium. The transceiver 1630 receives a signal from the one or more antennas 1635, extracts information from the received signal, and provides the extracted information to the processing system 1610, specifically the reception component 1502. In addition, the transceiver 1630 receives information from the processing system 1610, specifically the transmission component 1504, and generates a signal to be applied to the one or more antennas 1635 based at least in part on the received information.

The processing system 1610 includes one or more processors 1620 coupled to a computer-readable medium/memory 1625. A processor 1620 is responsible for general processing, including the execution of software stored on the computer-readable medium/memory 1625. The software, when executed by the processor 1620, causes the processing system 1610 to perform the various functions described herein for any particular apparatus. The computer-readable medium/memory 1625 may also be used for storing data that is manipulated by the processor 1620 when executing software. The processing system further includes at least one of the illustrated components. The components may be software modules running in the processor 1620, resident/stored in the computer readable medium/memory 1625, one or more hardware modules coupled to the processor 1620, or some combination thereof.

In some aspects, the processing system 1610 may be a component of the UE 120 and may include one or more memories, such as the memory 282, and/or may include one or more processors, such as at least one of the TX MIMO processor 266, the RX processor 258, and/or the controller/processor 280. In some aspects, the apparatus 1605 for wireless communication includes means for mapping UCI bits and UL-SCH data bits to a first subset of resources associated with a PUSCH; means for copying symbols associated with the UCI bits and the UL-SCH data bits from the first subset of resources to one or more remaining subsets of resources associated with the PUSCH, to obtain copied symbols associated with the UCI bits and the UL-SCH data bits, based at least in part on a repetition pattern; means for applying an OCC across a plurality of subsets of resources, including the first subset of resources and the one or more remaining subsets of resources, associated with the PUSCH based at least in part on the repetition pattern; and/or means for transmitting, based at least in part on the OCC applied across the plurality of subsets of resources, multiplexed UCI bits and UL-SCH data bits, the multiplexed UCI bits and UL-SCH data bits being based at least in part on the symbols associated with the UCI bits and the UL-SCH bits associated with the first subset of resources and the copied symbols associated with the UCI bits and the UL-SCH data bits associated with the one or more remaining subsets of resources. The aforementioned means may be one or more of the aforementioned components of the apparatus 1500 and/or the processing system 1610 of the apparatus 1605 configured to perform the functions recited by the aforementioned means. As described elsewhere herein, the processing system 1610 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 16 is provided as an example. Other examples may differ from what is described in connection with FIG. 16.

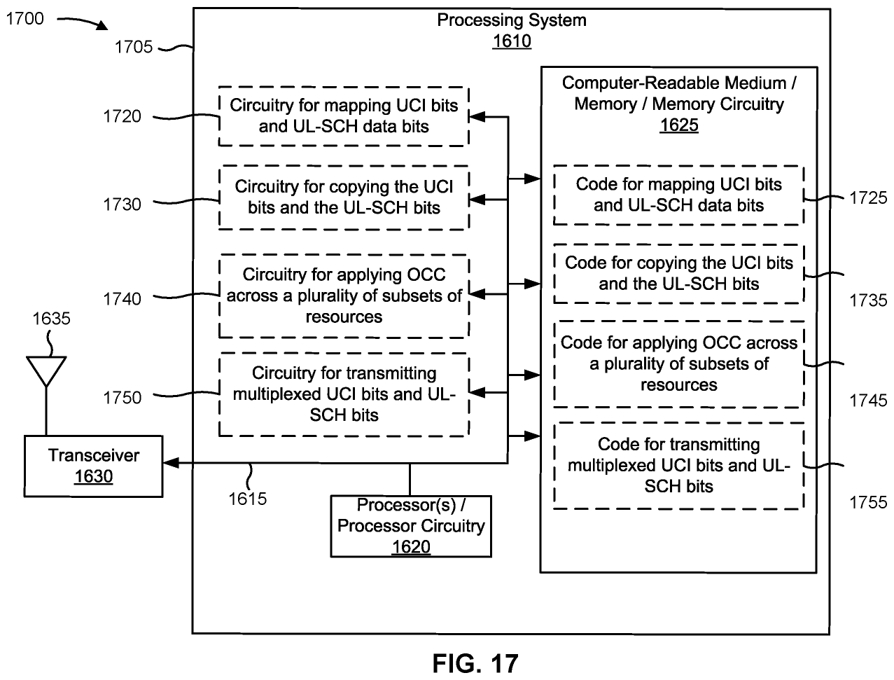

FIG. 17 is a diagram illustrating an example 1700 of an implementation of code and circuitry for an apparatus 1705, in accordance with the present disclosure. The circuitry may include processing circuitry and memory circuitry. The apparatus 1705 may be a UE, or a UE may include the apparatus 1705.

As shown in FIG. 17, the apparatus 1705 may include circuitry for mapping UCI bits and UL-SCH data bits to a first subset of resources associated with a PUSCH (circuitry 1720). For example, the circuitry 1720 may enable the apparatus 1705 to map UCI bits and UL-SCH data bits to a first subset of resources associated with a PUSCH.

As shown in FIG. 17, the apparatus 1705 may include, stored in computer-readable medium 1625, code for mapping UCI bits and UL-SCH data bits to a first subset of resources associated with a PUSCH (code 1725). For example, the code 1725, when executed by processor 1620, may cause processor 1620 to map UCI bits and UL-SCH data bits to a first subset of resources associated with a PUSCH.

As shown in FIG. 17, the apparatus 1705 may include circuitry for copying symbols associated with the UCI bits and the UL-SCH data bits from the first subset of resources to one or more remaining subsets of resources associated with the PUSCH, to obtain copied symbols associated with the UCI bits and the UL-SCH data bits, based at least in part on a repetition pattern (circuitry 1730). For example, the circuitry 1730 may enable the apparatus 1705 to copy symbols associated with the UCI bits and the UL-SCH data bits from the first subset of resources to one or more remaining subsets of resources associated with the PUSCH, to obtain copied symbols associated with the UCI bits and the UL-SCH data bits, based at least in part on a repetition pattern.

As shown in FIG. 17, the apparatus 1705 may include, stored in computer-readable medium 1625, code for copying symbols associated with the UCI bits and the UL-SCH data bits from the first subset of resources to one or more remaining subsets of resources associated with the PUSCH, to obtain copied symbols associated with the UCI bits and the UL-SCH data bits, based at least in part on a repetition pattern (code 1735). For example, the code 1735, when executed by processor 1620, may cause processor 1620 to copy symbols associated with the UCI bits and the UL-SCH data bits from the first subset of resources to one or more remaining subsets of resources associated with the PUSCH, to obtain copied symbols associated with the UCI bits and the UL-SCH data bits, based at least in part on a repetition pattern.

As shown in FIG. 17, the apparatus 1705 may include circuitry for applying an OCC across a plurality of subsets of resources, including the first subset of resources and the one or more remaining subsets of resources, associated with the PUSCH based at least in part on the repetition pattern (circuitry 1740). For example, the circuitry 1740 may enable the apparatus 1705 to apply an OCC across a plurality of subsets of resources, including the first subset of resources and the one or more remaining subsets of resources, associated with the PUSCH based at least in part on the repetition pattern.

As shown in FIG. 17, the apparatus 1705 may include, stored in computer-readable medium 1625, code for applying an OCC across a plurality of subsets of resources, including the first subset of resources and the one or more remaining subsets of resources, associated with the PUSCH based at least in part on the repetition pattern (code 1745). For example, the code 1745, when executed by processor 1620, may cause processor 1620 to apply an OCC across a plurality of subsets of resources, including the first subset of resources and the one or more remaining subsets of resources, associated with the PUSCH based at least in part on the repetition pattern.

As shown in FIG. 17, the apparatus 1705 may include circuitry for transmitting, based at least in part on the OCC applied across the plurality of subsets of resources, multiplexed UCI bits and UL-SCH data bits, the multiplexed UCI bits and UL-SCH data bits being based at least in part on the symbols associated with the UCI bits and the UL-SCH bits associated with the first subset of resources and the copied symbols associated with the UCI bits and the UL-SCH data bits associated with the one or more remaining subsets of resources (circuitry 1750). For example, the circuitry 1750 may enable the apparatus 1705 to transmit, based at least in part on the OCC applied across the plurality of subsets of resources, multiplexed UCI bits and UL-SCH data bits, the multiplexed UCI bits and UL-SCH data bits being based at least in part on the symbols associated with the UCI bits and the UL-SCH bits associated with the first subset of resources and the copied symbols associated with the UCI bits and the UL-SCH data bits associated with the one or more remaining subsets of resources.

As shown in FIG. 17, the apparatus 1705 may include, stored in computer-readable medium 1625, code for transmitting, based at least in part on the OCC applied across the plurality of subsets of resources, multiplexed UCI bits and UL-SCH data bits, the multiplexed UCI bits and UL-SCH data bits being based at least in part on the symbols associated with the UCI bits and the UL-SCH bits associated with the first subset of resources and the copied symbols associated with the UCI bits and the UL-SCH data bits associated with the one or more remaining subsets of resources (code 1755). For example, the code 1755, when executed by processor 1620, may cause processor 1620 to cause transceiver 1630 to transmit, based at least in part on the OCC applied across the plurality of subsets of resources, multiplexed UCI bits and UL-SCH data bits, the multiplexed UCI bits and UL-SCH data bits being based at least in part on the symbols associated with the UCI bits and the UL-SCH bits associated with the first subset of resources and the copied symbols associated with the UCI bits and the UL-SCH data bits associated with the one or more remaining subsets of resources.

FIG. 17 is provided as an example. Other examples may differ from what is described in connection with FIG. 17.

The following provides an overview of some Aspects of the present disclosure:

Aspect 1: A method of wireless communication performed at a user equipment (UE), comprising: mapping uplink control information (UCI) bits and uplink shared channel (UL-SCH) data bits to a first subset of resources associated with a physical uplink shared channel (PUSCH); copying symbols associated with the UCI bits and the UL-SCH data bits from the first subset of resources to one or more remaining subsets of resources associated with the PUSCH, to obtain copied symbols associated with the UCI bits and the UL-SCH data bits, based at least in part on a repetition pattern; applying an orthogonal cover code (OCC) across a plurality of subsets of resources, including the first subset of resources and the one or more remaining subsets of resources, associated with the PUSCH based at least in part on the repetition pattern; and transmitting, based at least in part on the OCC applied across the plurality of subsets of resources, multiplexed UCI bits and UL-SCH data bits, the multiplexed UCI bits and UL-SCH data bits being based at least in part on the symbols associated with the UCI bits and the UL-SCH bits associated with the first subset of resources and the copied symbols associated with the UCI bits and the UL-SCH data bits associated with the one or more remaining subsets of resources.

Aspect 2: The method of Aspect 1, wherein subcarriers allocated to the PUSCH are partitioned into the plurality of subsets of resources, and the first subset of resources is associated with a plurality of contiguous subcarriers or a plurality of non-contiguous subcarriers.

Aspect 3: The method of any of Aspects 1-2, wherein demodulation reference signal (DMRS) symbols are excluded from the OCC, and UCI bits or UL-SCH data bits are excluded from being mapped to one or more unused resource elements (REs) of a symbol occupied by DMRS.

Aspect 4: The method of any of Aspects 1-3, wherein demodulation reference signal (DMRS) symbols are included for the OCC, and UL-SCH data bits are mapped to one or more unused resource elements (REs) of a symbol occupied by DMRS.

Aspect 5: The method of any of Aspects 1-4, wherein the OCC is a frequency domain OCC applied by multiplying an OCC codeword across the plurality of subsets of resources.

Aspect 6: The method of any of Aspects 1-5, wherein symbols allocated to the PUSCH are partitioned into the plurality of subsets of resources, and the first subset of resources is associated with a plurality of contiguous symbols or a plurality of non-contiguous symbols.

Aspect 7: The method of any of Aspects 1-6, wherein demodulation reference signal (DMRS) symbols are excluded from the OCC, and the UCI bits or the UL-SCH data bits are excluded from being mapped to the plurality of subsets of resources.

Aspect 8: The method of any of Aspects 1-7, wherein demodulation reference signal (DMRS) symbols are included for the OCC, and at least one of the DMRS symbols is excluded from the first subset of resources.

Aspect 9: The method of Aspect 8, wherein one or more DMRS resource elements (REs) in a symbol of a comb that is nearest to a DMRS symbol, in relation to other DMRS REs, are marked as unavailable.

Aspect 10: The method of Aspect 8, wherein information associated with a DMRS resource element (RE) is copied to a symbol in a comb that is nearest to a DMRS symbol, in relation to other DMRS symbols.

Aspect 11: The method of any of Aspects 1-10, wherein the OCC is a symbol-level OCC applied by multiplying, in a time domain, an OCC codeword across the plurality of subsets of resources.

Aspect 12: The method of any of Aspects 1-11, wherein one or more unused resource elements (REs) on demodulation reference signal (DMRS) symbols are used for the UL-SCH data bits with the OCC, and the DMRS symbols fall into the first subset of resources.

Aspect 13: The method of any of Aspects 1-12, wherein one or more unused resource elements (REs) on demodulation reference signal (DMRS) symbols are used for the UL-SCH data bits with the OCC, and a portion of DMRS symbols fall outside of the first subset of resources.

Aspect 14: The method of any of Aspects 1-13, wherein slots allocated to the PUSCH are partitioned into the plurality of subsets of resources, and the first subset of resources is associated with a plurality of contiguous slots or a plurality of non-contiguous slots.

Aspect 15: The method of any of Aspects 1-14, wherein the OCC is a slot-level OCC applied by multiplying, in a time domain, an OCC codeword across the plurality of subsets of resources.

Aspect 16: The method of any of Aspects 1-15, wherein the OCC is associated with multiple OCC schemes simultaneously applied in a frequency domain and in a time domain.

Aspect 17: The method of any of Aspects 1-16, wherein a number of resource elements (REs) for the multiplexed UCI bits and UL-SCH data bits is based at least in part on a spreading factor for the PUSCH, and the spreading factor is based at least in part on the repetition pattern.

Aspect 18: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-17.

Aspect 19: An apparatus for wireless communication at a device, the apparatus comprising one or more memories and one or more processors coupled to the one or more memories, the one or more processors configured to cause the device to perform the method of one or more of Aspects 1-17.

Aspect 20: An apparatus for wireless communication, the apparatus comprising at least one means for performing the method of one or more of Aspects 1-17.

Aspect 21: A non-transitory computer-readable medium storing code for wireless communication, the code comprising instructions executable by one or more processors to perform the method of one or more of Aspects 1-17.

Aspect 22: A non-transitory computer-readable medium storing a set of instructions for wireless communication, the set of instructions comprising one or more instructions that, when executed by one or more processors of a device, cause the device to perform the method of one or more of Aspects 1-17.

Aspect 23: A device for wireless communication, the device comprising a processing system that includes one or more processors and one or more memories coupled with the one or more processors, the processing system configured to cause the device to perform the method of one or more of Aspects 1-17.

Aspect 24: An apparatus for wireless communication at a user equipment (UE), comprising: a processing system that includes processor circuitry and memory circuitry that stores code and is coupled with the processor circuitry, the processing system configured to cause the UE to perform the method of one or more of Aspects 1-17.

Aspect 25: An apparatus for wireless communication at a user equipment (UE), the apparatus comprising one or more memories and one or more processors coupled to the one or more memories, the one or more processors configured to individually or collectively cause the UE to perform the method of one or more of Aspects 1-17.

Aspect 26: An apparatus for wireless communication at a user equipment (UE), comprising: a processing system that includes processor circuitry and memory circuitry that stores code and is coupled with the processor circuitry, the processing system configured to cause the UE to perform the method of one or more of Aspects 1-17.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
one or more memories; and
one or more processors coupled with the one or more memories and configured to cause the UE to:
map uplink control information (UCI) bits and uplink shared channel (UL-SCH) data bits to a first subset of resources associated with a physical uplink shared channel (PUSCH);
copy symbols associated with the UCI bits and the UL-SCH data bits from the first subset of resources to one or more remaining subsets of resources associated with the PUSCH, to obtain copied symbols associated with the UCI bits and the UL-SCH data bits, based at least in part on a repetition pattern;
apply an orthogonal cover code (OCC) across a plurality of subsets of resources, including the first subset of resources and the one or more remaining subsets of resources, associated with the PUSCH based at least in part on the repetition pattern; and
transmit, based at least in part on the OCC applied across the plurality of subsets of resources, multiplexed UCI bits and UL-SCH data bits, the multiplexed UCI bits and UL-SCH data bits being based at least in part on the symbols associated with the UCI bits and the UL-SCH bits associated with the first subset of resources and the copied symbols associated with the UCI bits and the UL-SCH data bits associated with the one or more remaining subsets of resources.

2. The apparatus of claim 1, wherein subcarriers allocated to the PUSCH are partitioned into the plurality of subsets of resources, and the first subset of resources is associated with a plurality of contiguous subcarriers or a plurality of non-contiguous subcarriers.

3. The apparatus of claim 1, wherein demodulation reference signal (DMRS) symbols are excluded from the OCC, and the UCI bits or the UL-SCH data bits are excluded from being mapped to one or more unused resource elements (REs) of a symbol occupied by DMRS.

4. The apparatus of claim 1, wherein demodulation reference signal (DMRS) symbols are included for the OCC, and the UL-SCH data bits are mapped to one or more unused resource elements (REs) of a symbol occupied by DMRS.

5. The apparatus of claim 1, wherein the OCC is a frequency domain OCC applied by multiplying an OCC codeword across the plurality of subsets of resources.

6. The apparatus of claim 1, wherein symbols allocated to the PUSCH are partitioned into the plurality of subsets of resources, and the first subset of resources is associated with a plurality of contiguous symbols or a plurality of non-contiguous symbols.

7. The apparatus of claim 1, wherein demodulation reference signal (DMRS) symbols are excluded from the OCC, and the UCI bits or the UL-SCH data bits are excluded from being mapped to the plurality of subsets of resources.

8. The apparatus of claim 1, wherein demodulation reference signal (DMRS) symbols are included for the OCC, and at least one of the DMRS symbols is excluded from the first subset of resources.

9. The apparatus of claim 8, wherein one or more DMRS resource elements (REs) in a symbol of a comb that is nearest to a DMRS symbol, in relation to other DMRS REs, are marked as unavailable.

10. The apparatus of claim 8, wherein information associated with a DMRS resource element (RE) is copied to a symbol in a comb that is nearest to a DMRS symbol, in relation to other DMRS symbols.

11. The apparatus of claim 1, wherein the OCC is a symbol-level OCC applied by multiplying, in a time domain, an OCC codeword across the plurality of subsets of resources.

12. The apparatus of claim 1, wherein one or more unused resource elements (REs) on demodulation reference signal (DMRS) symbols are used for the UL-SCH data bits with the OCC, and the DMRS symbols fall into the first subset of resources.

13. The apparatus of claim 1, wherein one or more unused resource elements (REs) on demodulation reference signal (DMRS) symbols are used for the UL-SCH data bits with the OCC, and a portion of DMRS symbols fall outside of the first subset of resources.

14. The apparatus of claim 1, wherein slots allocated to the PUSCH are partitioned into the plurality of subsets of resources, and the first subset of resources is associated with a plurality of contiguous slots or a plurality of non-contiguous slots.

15. The apparatus of claim 1, wherein the OCC is a slot-level OCC applied by multiplying, in a time domain, an OCC codeword across the plurality of subsets of resources.

16. The apparatus of claim 1, wherein the OCC is associated with multiple OCC schemes simultaneously applied in a frequency domain and in a time domain.

17. The apparatus of claim 1, wherein a number of resource elements (REs) for the multiplexed UCI bits and UL-SCH data bits is based at least in part on a spreading factor for the PUSCH, and the spreading factor is based at least in part on the repetition pattern.

18. A method of wireless communication performed at a user equipment (UE), comprising:
mapping uplink control information (UCI) bits and uplink shared channel (UL-SCH) data bits to a first subset of resources associated with a physical uplink shared channel (PUSCH);
copying symbols associated with the UCI bits and the UL-SCH data bits from the first subset of resources to one or more remaining subsets of resources associated with the PUSCH, to obtain copied symbols associated with the UCI bits and the UL-SCH data bits, based at least in part on a repetition pattern;
applying an orthogonal cover code (OCC) across a plurality of subsets of resources, including the first subset of resources and the one or more remaining subsets of resources, associated with the PUSCH based at least in part on the repetition pattern; and
transmitting, based at least in part on the OCC applied across the plurality of subsets of resources, multiplexed UCI bits and UL-SCH data bits, the multiplexed UCI bits and UL-SCH data bits being based at least in part on the symbols associated with the UCI bits and the UL-SCH bits associated with the first subset of resources and the copied symbols associated with the UCI bits and the UL-SCH data bits associated with the one or more remaining subsets of resources.

19. The method of claim 18, wherein subcarriers allocated to the PUSCH are partitioned into the plurality of subsets of resources, and the first subset of resources is associated with a plurality of contiguous subcarriers or a plurality of non-contiguous subcarriers.

20. The method of claim 18, wherein demodulation reference signal (DMRS) symbols are excluded from the OCC, and UCI bits or UL-SCH data bits are excluded from being mapped to one or more unused resource elements (REs) of a symbol occupied by DMRS.

21. The method of claim 18, wherein demodulation reference signal (DMRS) symbols are included for the OCC, and UL-SCH data bits are mapped to one or more unused resource elements (REs) of a symbol occupied by DMRS.

22. The method of claim 18, wherein the OCC is a frequency domain OCC applied by multiplying an OCC codeword across the plurality of subsets of resources.

23. The method of claim 18, wherein symbols allocated to the PUSCH are partitioned into the plurality of subsets of resources, and the first subset of resources is associated with a plurality of contiguous symbols or a plurality of non-contiguous symbols.

24. The method of claim 18, wherein demodulation reference signal (DMRS) symbols are excluded from the OCC, and the UCI bits or the UL-SCH data bits are excluded from being mapped to the plurality of subsets of resources.

25. The method of claim 18, wherein demodulation reference signal (DMRS) symbols are included for the OCC, and at least one of the DMRS symbols is excluded from the first subset of resources.

26. The method of claim 18, wherein the OCC is a symbol-level OCC applied by multiplying, in a time domain, an OCC codeword across the plurality of subsets of resources.

27. The method of claim 18, wherein slots allocated to the PUSCH are partitioned into the plurality of subsets of resources, and the first subset of resources is associated with a plurality of contiguous slots or a plurality of non-contiguous slots.

28. The method of claim 18, wherein the OCC is a slot-level OCC applied by multiplying, in a time domain, an OCC codeword across the plurality of subsets of resources.

29. A non-transitory computer-readable medium storing a set of instructions for wireless communication, the set of instructions comprising:
one or more instructions that, when executed by one or more processors of a user equipment (UE), cause the UE to:
map uplink control information (UCI) bits and uplink shared channel (UL-SCH) data bits to a first subset of resources associated with a physical uplink shared channel (PUSCH);
copy symbols associated with the UCI bits and the UL-SCH data bits from the first subset of resources to one or more remaining subsets of resources associated with the PUSCH, to obtain copied symbols associated with the UCI bits and the UL-SCH data bits, based at least in part on a repetition pattern;
apply an orthogonal cover code (OCC) across a plurality of subsets of resources, including the first subset of resources and the one or more remaining subsets of resources, associated with the PUSCH based at least in part on the repetition pattern; and
transmit, based at least in part on the OCC applied across the plurality of subsets of resources, multiplexed UCI bits and UL-SCH data bits, the multiplexed UCI bits and UL-SCH data bits being based at least in part on the symbols associated with the UCI bits and the UL-SCH bits associated with the first subset of resources and the copied symbols associated with the UCI bits and the UL-SCH data bits associated with the one or more remaining subsets of resources.

30. An apparatus for wireless communication, comprising:
means for mapping uplink control information (UCI) bits and uplink shared channel (UL-SCH) data bits to a first subset of resources associated with a physical uplink shared channel (PUSCH);
means for copying symbols associated with the UCI bits and the UL-SCH data bits from the first subset of resources to one or more remaining subsets of resources associated with the PUSCH, to obtain copied symbols associated with the UCI bits and the UL-SCH data bits, based at least in part on a repetition pattern;
means for applying an orthogonal cover code (OCC) across a plurality of subsets of resources, including the first subset of resources and the one or more remaining subsets of resources, associated with the PUSCH based at least in part on the repetition pattern; and
means for transmitting, based at least in part on the OCC applied across the plurality of subsets of resources, multiplexed UCI bits and UL-SCH data bits, the multiplexed UCI bits and UL-SCH data bits being based at least in part on the symbols associated with the UCI bits and the UL-SCH bits associated with the first subset of resources and the copied symbols associated with the UCI bits and the UL-SCH data bits associated with the one or more remaining subsets of resources.
